(19) United States
(12) Patent Application Publication
(10) Pub. No.: US 2026/0050849 A1
(43) Pub. Date: Feb. 19, 2026

(54) SYSTEMS AND METHODS FOR DEVELOPING AND IMPLEMENTING LANGUAGE GENERATION AND PROCESSING MODELS FOR A SKILL PROFICIENCY FRAMEWORK

(71) Applicant: PEARSON EDUCATION, INC., Bloomington, MN (US)

(72) Inventors: Mingzhao LI, Seaford (AU); Rebecca Mary DEW, Oaklands Park (AU); Sandya Gillian BARATHA RAJ, Alexandria (AU)

(21) Appl. No.: 19/300,269

(22) Filed: Aug. 14, 2025

Related U.S. Application Data
(60) Provisional application No. 63/683,929, filed on Aug. 16, 2024.

(51) Int. Cl. G06Q 10/0631; G06Q 10/1053; G06Q 50/20

(52) U.S. Cl. CPC G06Q 10/063112; G06Q 10/1053; G06Q 50/2057

(57) ABSTRACT

Systems and methods are provided for developing and implementing a skill proficiency framework. One system includes a processing system configured to access a skills ontology and generate skill proficiency descriptions for each skill included in the skills ontology. The processing system may be configured to generate a skill proficiency by occupation model that correlates an occupation to a skill, a respective proficiency level of the skill, and a corresponding skill proficiency description for the skill and the respective proficiency level of the skill. The processing system may be configured to provide an interactive visualization system based on the skill proficiency by occupation model.

### CROSS-REFERENCE TO RELATED APPLICATIONS

This application claims priority to U.S. Provisional Application No. 63/683,929, filed on Aug. 16, 2024, which is hereby incorporated by reference in its entirety.

### TECHNICAL FIELD

This disclosure relates to the field of systems and methods for developing and implementing language generation and processing models for a skill proficiency framework.

### SUMMARY

Continuous skill development and adaptation allow for both individuals and organizations to maintain competitiveness and relevance in today's dynamic job market. Understanding skill proficiency may directly impact job performance, career advancement, and the capacity to navigate industry shifts and technological advancements effectively. The technology disclosed herein provides a comprehensive skill proficiency framework to describe, assess, and develop proficiency in key skills, facilitating career development for individuals and aiding organizations in effective talent management and strategic workforce planning. In some configurations, the technology disclosed herein may provide a skill proficiency description pipeline that generates detailed statements outlining the skill requirements at each proficiency level for over 8,000 skills in a developed skills ontology. The technology disclosed herein further designs a skill proficiency by occupation model leveraging large-scale job ad data to help organizations and individuals understand the proficiency requirements for various occupations (at different seniority levels). In some configurations, the technology disclosed herein may be implemented in workforce planning, recruitment, education, career development, etc., demonstrating the value of the technology disclosed herein in enhancing, e.g., talent management and strategic adaptability.

One configuration may provide a system. The system may include a processing system including one or more electronic processors. The processing system may be configured to access a skills ontology that indicates a plurality of skills. The processing system may be configured to generate a plurality of skill proficiency descriptions for the plurality of skills. Each skill proficiency description of the plurality of skill proficiency descriptions may: (a) be specific to a respective skill of the plurality of skills and a corresponding proficiency level of the respective skill of the plurality of skills; and (b) indicate a corresponding requisite associated with performance of the respective skill at the corresponding proficiency level. The processing system may be configured to extract, from occupation data stored in an external database, a set of skills of the plurality of skills, the set of skills indicated by the occupation data. The processing system may be configured to determine, from the occupation data, a set of proficiency levels, where each skill of the set of skills may be associated with a respective proficiency level of the set of proficiency levels. The processing system may be configured to determine, from the occupation data, an occupation having a corresponding designation. The processing system may be configured to generate a model that correlates the occupation having the corresponding designation to a first skill proficiency description of the plurality of skill proficiency descriptions, where the first skill proficiency description may indicate a first requisite associated with performing a first skill of the set of skills at a first respective proficiency level of the set of proficiency levels.

Another configuration may provide a method. The method may include accessing, with a processing system including one or more electronic processors, a skills ontology that indicates a plurality of skills. The method may include generating, with the processing system, using a large language model (LLM), a first skill proficiency description for a first skill of the plurality of skills, where the first skill proficiency description may be specific to the first skill and a first corresponding proficiency level of the first skill, and where the first skill proficiency description may indicate a first requisite associated with performance of the first skill at the first corresponding proficiency level. The method may include accessing, with the processing system, external occupation data related to a plurality of occupations. The method may include determining, with the processing system, based on the external occupation data, a mapping that correlates each occupation of the plurality of occupations to a respective set of skills of the plurality of skills, where each skill of the respective set of skills may be associated with a respective proficiency level. The method may include generating, with the processing system, based on the mapping, a model that correlates a first occupation of the plurality of occupations to the first skill proficiency description. The method may include generating, with the processing system, a user interface including an interactive graphical representation of the model. The method may include transmitting, with the processing system, the user interface including the interactive graphical representation of the model to a user device for display by a display device of the user device.

Yet another configuration may provide a non-transitory, computer-readable medium storing instructions that, when executed by an electronic processor, perform a set of functions. The set of functions may include accessing a skills ontology that indicates a plurality of skills. The set of functions may include developing a plurality of LLM prompts to generate a plurality of skill proficiency descriptions for the plurality of skills, where each LLM prompt of the plurality of LLM prompts may be specific to a corresponding skill of the plurality of skills and may be based on a skill type of the corresponding skill of the plurality of skills. The set of functions may include executing a plurality of LLM queries using the plurality of LLM prompts to generate the plurality of skill proficiency descriptions for the plurality of skills, where each skill proficiency description of the plurality of skill proficiency descriptions may: (a) be specific to a respective skill of the plurality of skills and a corresponding proficiency level of the respective skill of the plurality of skills; and (b) indicate a corresponding requisite associated with performance of the respective skill at the corresponding proficiency level. The set of functions may include extracting, from occupation data stored in an external database, a set of skills of the plurality of skills, the set of skills indicated by the occupation data. The set of functions may include determining, from the occupation data, a set of proficiency levels, where each skill of the set of skills may be associated with a respective proficiency level of the set of proficiency levels. The set of functions may include determining, from the occupation data, an occupation having a corresponding designation. The set of functions may include generating a mapping the occupation having the corresponding designation to the set of skills and the set of proficiency levels. The set of functions may include generating, based on the mapping, a model that correlates the occupation having the corresponding designation to a first skill proficiency description of the plurality of skill proficiency descriptions, where the first skill proficiency description may indicate a first requisite associated with performing a first skill of the set of skills at a first respective proficiency level of the set of proficiency levels.

This Summary and the Abstract are provided to introduce a selection of concepts in a simplified form that are further described below in the Detailed Description. The Summary and the Abstract are not intended to identify key features or essential features of the claimed subject matter, nor are they intended to be used as an aid in determining the scope of the claimed subject matter.

### BRIEF DESCRIPTION OF THE DRAWINGS

The following drawings are provided to help illustrate various features of examples of the disclosure and are not intended to limit the scope of the disclosure or exclude alternative implementations.

FIG. 1 illustrates an overview of a skill proficiency framework in accordance with some configurations.

FIG. 2 schematically illustrates a system for implementing the skill proficiency framework in accordance with some configurations.

FIG. 3 schematically illustrates a server included in the system of FIG. 2 in accordance with some configurations.

FIG. 4 is a flowchart illustrating an example method to generate a set of proficiency descriptions in accordance with some configurations.

FIG. 5 is a flowchart illustrating an example method to generate a skill proficiency by occupation model in accordance with some configurations.

FIGS. 6A-6C illustrate a graph of example statistics related to a data scientist in accordance with some configurations.

FIG. 7 illustrates an example career pathways user interface of an interactive visualization system in accordance with some configurations.

FIGS. 8A-8B illustrate an example skill gap user interface of an interactive visualization system in accordance with some configurations.

FIG. 9 illustrates an example skill proficiency user interface of an interactive visualization system in accordance with some configurations.

FIG. 10 is a table illustrating example top skills associated with a junior data scientist in accordance with some configurations.

FIG. 11 is a table illustrating example skill proficiency descriptions associated with various skill proficiency levels for Python in accordance with some configurations.

### DETAILED DESCRIPTION OF THE PRESENT DISCLOSURE

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by one or more networks or other suitable communication links.

Qualifications in the workforce are constantly changing due to, e.g., technological advancements, changes in the business environment, the evolving nature of work, or the like. When applying a skill to complete a task at work, a certain proficiency in that skill is a prerequisite to achieve the desired outcome. Across the job market, there is a range of demand for different skills at various proficiency levels for any given occupation. Proficiency criteria differ across industry sectors and roles, vary by seniority, and change over time in response to the adoption of new technology, the availability and popularity of products, and the introduction of regulations. The identification and description of the prerequisite proficiency levels as well as the measurement of whether these prerequisites are met may facilitate an understanding of these differences.

A clear definition of the requisite skills and proficiency levels for different roles may allow for individuals to effectively plan their career pathways and for managers to implement appropriate professional development programs. These definitions may also allow for organizations to strategically plan their workforce and, for recruiters, to identify and hire the right talent to meet organizational goals. Understanding skill proficiency further extends to education and training providers who seek to design curricula that meet the conditions of the workforce.

Understanding skill proficiency may involve describing what the corresponding prerequisites are and then measuring (or determining) whether the corresponding prerequisites are met. However, describing proficiency, that is, how well a particular user can do something, is difficult. For instance, a mere statement that a user is ‘good’ at a skill does not explain what that user can do, what that user can do relative to someone who is ‘very good’, or whether this is good enough to complete a task at work to the requisite standard.

Proficiency frameworks provide a standardized way to describe, measure, and benchmark performance in a skill. Proficiency frameworks outline what is expected at each proficiency level by describing the related requisite skills, knowledge, or capabilities. This simplifies the assessment of an individual's current proficiency in a skill and helps to identify areas for improvement. Proficiency frameworks may establish a common language to describe proficiency across occupations, which may allow for a comparison of proficiency requisites across different roles or industries.

Some proficiency frameworks for skill proficiency, such as, e.g., the European e-Competence Framework (e-CF) or the Skills Framework for the Information Age (SFIA) have been developed by some governments, industries, and organizations. Despite the development of some proficiency frameworks, there is still an ongoing need for continued development of such proficiency frameworks. For example, these proficiency frameworks are very time-consuming to develop and, therefore, struggle to stay current (or up to date) with changes in the job market or technology. Many of these proficiency frameworks either do not provide guidelines on the requisite proficiency levels for specific jobs, or only cover a limited number of skills or occupations, making it difficult to determine role prerequisites and benchmark performance.

Recent advancements or applications in large language models (LLMs) have significantly improved the efficiency and effectiveness of content generation for education and workforce planning. For instance, one application introduced an AI-based approach to integrate additional learning content, named narrative fragments, into learning pathways to form interactive learning narratives. Another application evaluated the performance of LLMs in an educational context by tagging math problems with relevant skills or standards. However, the application of LLMs for generating skill proficiency descriptions and mapping those skill proficiency descriptions to occupations using large-scale occupation data has yet to be explored. Moreover, as the use of LLMs becomes more prevalent in education and workforce planning, addressing issues related to bias and transparency in their usage remains a significant concern that warrants further exploration.

The technology disclosed herein provides a robust skill proficiency framework that offers a structured method to describe, assess, and develop proficiency in key skills, facilitating individuals' career pathways and aiding organizations in talent management and adaptability. For instance, the technology disclosed herein may provide for the development and implementation of a skill proficiency description pipeline, which generates statements describing the skill requisites at each proficiency level for skills in in a developed skills ontology (e.g., over 8,000 skills of the skills ontology). The technology disclosed herein may provide for the development and implementation of a skill proficiency by occupation model using large-scale occupation data (e.g., job postings or listings). In some instances, such a skill proficiency by occupation model may be implemented to help organizations and individuals understand the skill proficiency requisites for different roles. In some configurations, the technology disclosed herein may provide for the implementation or application of the framework described herein (e.g., including the skill proficiency description pipeline, the skill proficiency by occupation model, or a combination thereof) in, e.g., workforce planning, education, career development, and other areas.

Existing skill proficiency frameworks are associated with a number of challenges. As one example, some frameworks involve subjectivity, such as, e.g., subjectivity in skill proficiency descriptions. For instance, some frameworks commonly use terms such as “good,” “very good,” or “experienced,” which are highly subjective and vary in meaning across individuals, organizations, roles, etc. Such inconsistency hampers the ability to accurately compare proficiency levels. Accordingly, as described herein, the technology disclosed herein provides methods and systems that mitigate such inconsistencies by limiting (or eliminating) such subjectivity. As another example, existing frameworks are not standardized. Although some governments and organizations have developed skill proficiency frameworks (e.g., European e-Competence Framework (e-CF), Skills Framework for the Information Age (SFIA)), these frameworks are often limited in scope, covering only a few skills. They also require extensive time and effort to develop, making them prone to becoming outdated quickly in the fast-evolving job market. As yet another example, there is an absence of specific role recommendations. For instance, existing frameworks often fail to provide detailed role-specific proficiency requisites. This absence makes assessing role requisites challenging and introduces subjectivity, which further limits the ability to benchmark and compare skill levels across different teams or industries. As yet another example, frameworks may be outdated. Traditional skill frameworks struggle to keep pace with the rapid changes in the job market, leading to outdated information that does not accurately reflect current industry needs. This misalignment can hinder both individual career planning and organizational talent management.

To solve these and other technical problems described herein, the technology disclosed herein provides for a reliable, standardized method to describe, assess, and develop skill proficiency. Accurate skill proficiency modeling allows for: Career Pathway Planning (e.g., individuals need clear guidelines to effectively plan and navigate their career trajectories); Training Program Implementation (e.g., managers require detailed proficiency information to design and implement relevant training programs); Strategic Talent Management (e.g., organizations must manage talent strategically and adapt to evolving environments based on precise skill requirements); etc.

Previous efforts to address these challenges include the development of various skill proficiency frameworks such as: (a) European a-Competence Framework (c-CF), which is a widely recognized framework in Europe that defines IT competences, skills, and proficiency levels; however, it is limited in scope and can become outdated quickly; and (b) Skills Framework for the Information Age (SFIA), which is another recognized framework that provides a consistent vocabulary for describing skills and proficiency levels; however, despite its utility, it faces similar limitations regarding scope and timeliness. These frameworks, while valuable, have significant drawbacks, including: (a) limited skill coverage, as they often cover only a limited number of skills, leaving many emerging and evolving skills unaddressed; (b) time-consuming development, as the development process for these frameworks is lengthy, resulting in a lag between the identification of skill needs and the availability of updated proficiency descriptions; and (c) lack of specific role recommendations, as the frameworks often lack detailed recommendations for specific roles, leading to difficulties in accurately assessing and comparing role-specific skill requisites.

The technology disclosed herein aims to overcome these limitations by providing a comprehensive, up-to-date, and role-specific skill proficiency modeling framework, thus providing a more effective solution in workforce development and talent management.

Accordingly, the technology disclosed herein provides technical improvements and advantages over other skill proficiency frameworks. For instance, the technology disclosed herein provides methods and systems that may advantageously provide for improved handling of dynamic data. For instance, as described herein, requisites (or qualifications) in the workforce are constantly changes, and, in some instances, without notice or unexpectedly. As such, the technology disclosed herein provides improvements in the handling of dynamic data such that the skill proficiency framework disclosed herein may be efficiently maintained.

Additionally, the technology disclosed herein may allow for the standardization of source data (e.g., third-party controlled data accessible by the technology disclosed herein). In some examples, the technology disclosed herein may manipulate source data such that variances or discrepancies are mitigated or corrected. As one example scenario, a first data source may be a first third-party entity and a second data source may be a second third-party entity and the source data may include a first job posting for the first third-party entity and a second job posting for the second third party entity, where the first job posting and the second job posting are indicated as being for the same job title or occupation (e.g., a junior level data scientist). The first job posting may indicate a first set of skill proficiency requisites and the second job posting may indicate a second set of skill proficiency requisites. In some instances, the first set of skill proficiency requisites and the second set of skill proficiency requisites may be inconsistent (despite the fact that both job postings are for the same job tilt, a senior level data scientist). As described in greater detail herein, the technology disclosed herein allows for the correction or mitigation of such inconsistencies.

In some instances, the technology disclosed herein may advantageously standardize source data by identifying missing source data and generating source data to fill in such gaps in the source data. As one example, the source data may be a job posting for a senior accountant. The job posting may indicate a set of skill proficiency requisites for a senior accountant. However, the job positing may be incomplete in the sense that the set of skill proficiency requisites may not include all skill proficiency requisites for a senior accountant. For instance, the job posting may presume that an applicant will possess skill proficiency requisites associated with a junior accountant As a specific example, being advanced in spreadsheets may be a requisite of both a senior accountant and a mid-level accountant. However, following this example, a job positing for a senior accountant may not include being advanced in spreadsheets as a requisite as it may be presumed that any candidate applying for a senior accountant position would be advanced in spreadsheets. As such, the technology disclosed herein advantageously extrapolate source data in order to handle otherwise missing or unknown source data points.

Another example of the technical improvements and advantages provided by the technology disclosed herein relates to improved validity and accuracy with respect to data utilized by the technology disclosed herein. For instance, the technology disclosed herein may implement various verification or validation protocols to ensure increased data quality, validity, or accuracy, such as, e.g., with respect to the source data or data generated based on the source data, including, e.g., one or more models disclosed herein. Further, in some instances, the technology disclosed herein may manipulate or transform data in order to rectify any potential validity, bias, or accuracy concerns discovered as a result of the verification or validation protocols disclosed herein. For instance, as descripted in greater detail herein, the technology disclosed herein may execute one or more of a vocabulary diversification model, a bias removal model, a framework comparison model, an alignment model, etc. in order to improve the validity and accuracy of the data implemented by or within the skill proficiency framework described herein.

Further still, the technology disclosed herein may ensure improved accuracy and validity by ensuring the completeness of the data implemented by or within the skill proficiency framework disclosed herein. As one example, the technology disclosed herein advantageously is configured to handle various skill types (as opposed to just knowledge-based skill types as some frameworks do). The inclusion of various types of data allows for a more robust and complete skill proficiency framework, (or the model(s) utilized therein), which further improves the performance and applications of the skill proficiency framework described herein.

Additionally, a robust skill proficiency framework improves user experience, such as the user experience provided by the interactive visualization system as described herein. For instance, the more robust and complete the skill proficiency framework is, the more robust and complete the information presented to a user may be. As one example, by including various skill types in the skill proficiency framework (e.g., including the models thereof), a user of the interactive visualization system may be provided a more robust and complete outline of that user's career development, such that that user may be informed with respect to a diverse set of skills for achieving that user's career objectives. This further decreases user friction or frustration by broadening the insights provided via the interactive visualization system. Additionally, the interactive visualization system provides an improved user experience by advantageously encompassing various applications (or applicable users), such as, e.g., individuals and career advisors, recruiters and hiring managers, employers and HR professionals, or educators and training providers. Further, the technology disclosed herein (e.g., the interactive visualization system) advantageously provides a targeted or tailored information or insights to users. As one example, the interactive visualization system may be utilized to develop personal development plans for various users, industries, etc.

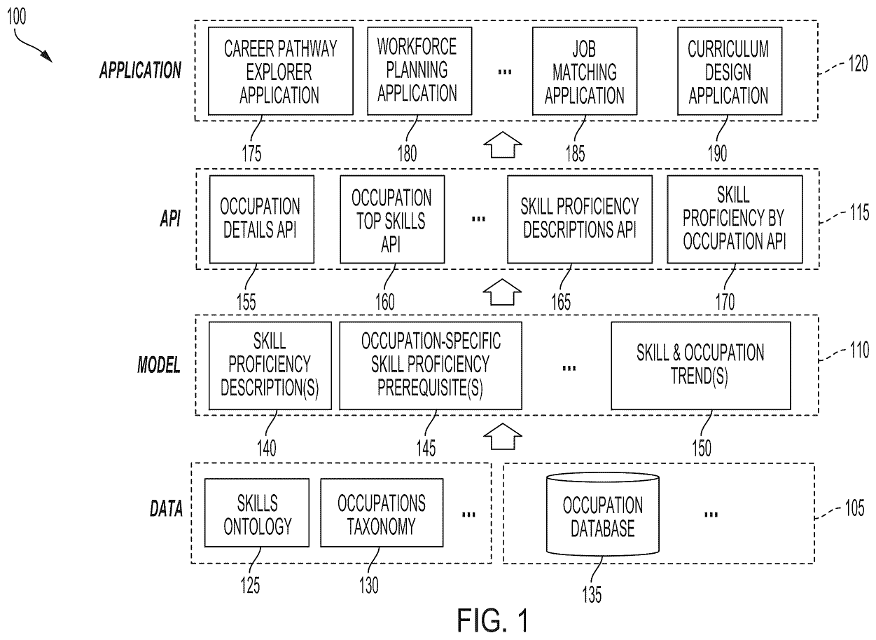

FIG. 1 illustrates an overview of the skill proficiency framework described herein. For instance, FIG. 1 illustrates an example of a proficiency descriptions generation pipeline 100 (also referred to herein as “the pipeline 100”) in accordance with some configurations herein. As illustrated in FIG. 1, the pipeline 100 may include a data layer 105, a model layer 110, an application programing interface (API) layer 115, and an application layer 120. The data layer 105 may include the data implemented or utilized by the technology disclosed herein. For instance, in some examples, as illustrated in FIG. 1, the data layer 105 may include a skills ontology 125, an occupations taxonomy 130, and an occupation database 135 storing third-party occupation data (as described in greater detail herein). The model layer 110 may include one or more outputs of the model(s) as described herein. For instance, in some examples, as illustrated in FIG. 1, the model layer 110 may include, as outputs, skill proficiency description(s) 140, occupation-specific skill proficiency prerequisite(s) 145, or skill and occupation trend(s) 150. As described in greater detail herein, the data included in the data layer 105 may be provided as inputs to the model(s) associated with the model layer 110, such that the outputs illustrated in FIG. 1 may be generated based on the data included in the data layer 105. The API layer 115 may include one or more APIs configured to communicate the outputs of the model layer 110, the data of the data layer 105, or a combination thereof to one or more applications of the application layer 120. For instance, in some examples, as illustrated in FIG. 1, the API layer 115 may include an occupation details API 155, an occupation top skills API 160, a skill proficiency descriptions API 165, or a skill proficiency by occupation API 170. The application layer 120 may include, e.g., a career pathway explorer application 175, a workforce planning application 180, a job matching application 185, a curriculum design application 190, etc.

Accordingly, as illustrated in FIG. 1, in some configurations, the skill proficiency framework described herein may be built on top of the skills ontology 125, the occupations taxonomy 130, or a combination thereof. The skills ontology 125 may define (or otherwise include) a comprehensive list of standardized skills, knowledge, or abilities relevant to the workforce and education. In some examples, the skills ontology 125 may include 334 transferable skills (e.g., communication, collaboration, etc.), and more than 8,000 specialized skills (e.g., Python, geology, nursing, etc.), which may cover all of the fields identified in the International Standard Classification of Education (ISCED). In some instances, the skills ontology 125 may be developed through expert review of skill-based entities extracted from employment data (e.g., job ads or credentials) and may be made available via an application programming interface (API). The occupation taxonomy 130 may define (or otherwise include) a list of standardized occupations that may be organized into various categories. As one example, the occupation taxonomy 130 may encompass 1,405 standardized occupations, categorized into Individual Contributor (IC), Manager, or Executive roles. The occupation taxonomy 130 may span multiple job families (e.g., 24 job families), including, e.g., Sales, Information, Communication and Technology (ICT), Medical, Military, etc. In some instances, each category (or stream thereof) may be further divided into levels of seniority. For example, each occupation within the IC stream (or category) and the Management stream (or category) may be further divided into four levels of seniority.

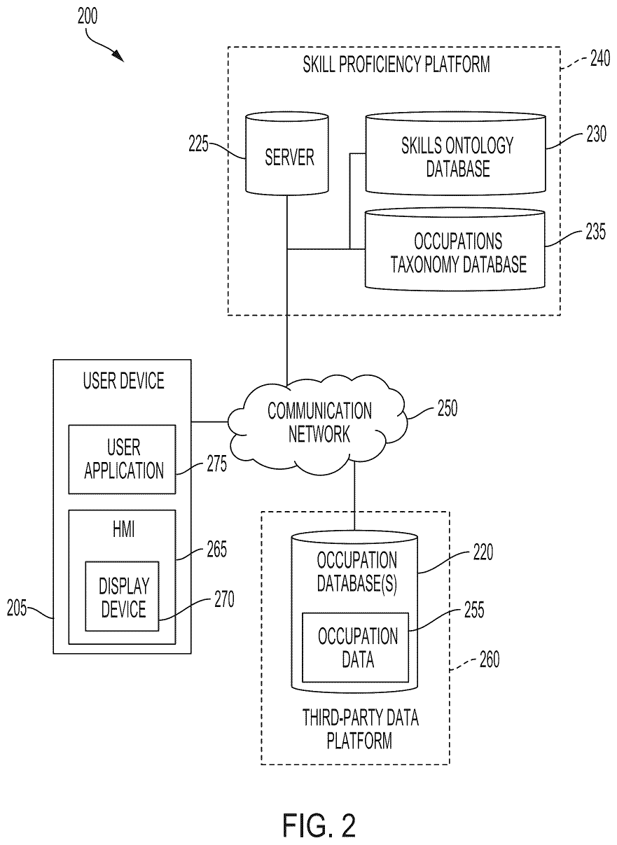

FIG. 2 illustrates a system 200 for implementing the skill proficiency framework described herein according to some configurations. In the illustrated example, the system 200 includes a user device 205, one or more occupation databases 220, a server 225, a skills ontology database 230, and an occupations taxonomy database 235. In some configurations, the system 200 includes fewer, additional, or different components than illustrated in FIG. 2 in different configurations. As one example, the system 200 may include multiple user devices 205, multiple servers 225, multiple skills ontology databases 230, multiple occupations taxonomy databases 235, or a combination thereof. As another example, one or more components of the system 200 may be combined into a single device. For instance, in some examples, the skills ontology database 230, the occupations taxonomy database 235, or a combination thereof may be combined into the server 225 such that the server 225 stores the information of the skills ontology database 230, the occupations taxonomy database 235, or a combination thereof. As yet another example, in some configurations, the server 225 and the user device 205 may be combined such that the user device 205 may perform the functionality (or a portion thereof) described herein as being performed by the server 225.

In some examples, the server 225, the skills ontology database 230, and the occupations taxonomy database 235 may be included within or referred to as a skill proficiency platform 240. As described in greater detail herein, the skill proficiency platform 240 may include one or more components configured to facilitate or implement the skill proficiency framework (or functionality thereof).

The user device 205, the occupation database(s) 220, the server 225, the skills ontology database 230, and the occupations taxonomy database 235 may communicate over one or more wired or wireless communication networks 250. Portions of the communication networks 250 may be implemented using a wide area network (“WAN”), such as the Internet, a local area network (“LAN”), such as a Bluetooth™ network or Wi-Fi, and combinations or derivatives thereof. Alternatively, or in addition, in some configurations, components of the system 200 communicate directly as compared to through the communication network 250. Also, in some configurations, the components of the system 200 may communicate through one or more intermediary devices not illustrated in FIG. 2.

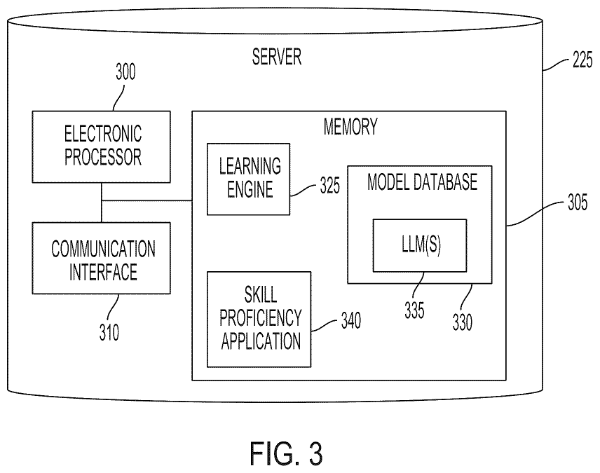

The server 225 may be a computing device. FIG. 3 schematically illustrates an example server 225 according to some configurations. As illustrated in FIG. 3, the server 225 includes an electronic processor 300, a memory 305, and a communication interface 310. The electronic processor 300, the memory 305, and the communication interface 310 may communicate wirelessly, over one or more communication lines or buses, or a combination thereof. The server 225 may include additional, different, or fewer components than those illustrated in FIG. 3 in various configurations. The server 225 may perform additional or different functionality than the functionality described herein. Also, the functionality (or a portion thereof) described herein as being performed by the server 225 may be performed by another component (e.g., the user device 205, another component of the system 200, or a combination thereof), distributed among multiple devices (e.g., as part of a cloud service or cloud-computing environment), combined with another component (e.g., the user device 205, another component of the system 200, or a combination thereof), or a combination thereof.

The communication interface 310 may include a transceiver that communicates with the occupation database(s) 220, the user device 205, the skills ontology database 230, the occupations taxonomy database 235, or a combination thereof over the communication network 250 and, optionally, one or more other communication networks or connections. The electronic processor 300 includes one or more processors (e.g., one or more microprocessors, one or more application-specific integrated circuits (“ASICs”), and/or one or more other suitable electronic device for processing data), and the memory 305 includes a non-transitory, computer-readable storage medium. The electronic processor 300 is configured to retrieve instructions and data from the memory 305 and execute the instructions.

As illustrated in FIG. 3, the memory 305 may store a learning engine 325 and a model database 330. In some configurations, the learning engine 325 develops one or more models using one or more machine learning functions. Machine learning functions are generally functions that allow a computer application to learn without being explicitly programmed. In particular, the learning engine 325 is configured to develop an algorithm or model based on training data. As one example, to perform supervised learning, the training data includes example inputs and corresponding desired (for example, actual) outputs, and the learning engine 325 progressively develops a model that maps inputs to the outputs included in the training data. As another example, to perform self-supervised learning (“SSL”), a model is trained on a task using the data itself to generate supervisory signals (e.g., unlabeled training data), rather than relying on, e.g., external labels provided by a user (e.g., labeled training data). As yet another example, to perform semi-supervised learning, the training data may include desired output values for a subset of the training data (e.g., labeled training data) while the remaining training data may be unlabeled or imprecisely labeled (e.g., unlabeled training data). Machine learning performed by the learning engine 325 may be performed using various types of methods and mechanisms including but not limited to decision tree learning, association rule learning, artificial neural networks, inductive logic programming, support vector machines, clustering, Bayesian networks, reinforcement learning, representation learning, similarity and metric learning, sparse dictionary learning, and genetic algorithms. These approaches allow the learning engine 325 to ingest, parse, and understand data and progressively refine models.

Alternatively, or in addition, in some configurations, the learning engine 325 may generate (or otherwise develop) one or more additional AI or machine learning models to perform the functionality (or a portion thereof) as described herein with respect to the skill proficiency framework. For example, in some configurations, the learning engine 325 may generate one or more models configured to output the skill proficiency description(s) 140, the occupation-specific skill proficiency prerequisite(s) 145, the skill and occupation trend(s) 150, etc., as illustrated in FIG. 1.

Alternatively, or in addition, in some configurations, the learning engine 325 may generate: a skill type differentiation model, configured to identify a corresponding skill type of a skill (e.g., a skill included in the skill ontology 125), as described in greater detail herein; a skill proficiency description generation model, configured to generate a skill proficiency description, as described in greater detail herein; a vocabulary diversification model, configured to diversify language included in a generated skill proficiency description to mitigate repetition relative to other generated skill proficiency descriptions, as described in greater detail herein; a bias removal model, configured to mitigate or remove vias from a generated skill proficiency description, as described in greater detail herein; a framework comparison model, configured to compare frameworks for a selected skill, as described in greater detail herein; an alignment model, configured to determine whether a framework aligns with a given course description, as described in greater detail herein; a named entity recognition (NER) model, configured to extract or identify skill entities from occupation data (e.g., job positing(s)), as described in greater detail herein; an encoder-based model, configured to extract or identify a skill or a skill proficiency level from, e.g., a job posting (e.g., the occupation data 255), as described in greater detail herein; a job matching model, configured to extract or identify an occupation from a job posting or map an extracted occupation to an occupation in the occupation taxonomy 130, as described in greater detail herein; a statistic model, configured to generate or determine skill proficiency statistics by occupation, as described in greater detail herein; or another model configured to perform functionality (or a portion thereof) related to the skill proficiency framework as described herein.

Models generated by the learning engine 325 can be stored in the model database 330. As illustrated in FIG. 3, the model database 330 may be included in the memory 305 of the server 225. It should be understood, however, that, in some configurations, the model database 330 may be included in one or more separate devices accessible by the server 225 of FIG. 3 (including a remote database, and the like).

As described in greater detail herein, in some configurations, the technology disclosed herein may utilize or implement one or more LLMs as part of developing and implementing the skills proficiency framework, such as, e.g., with respect to generation of skill proficiency descriptions, generation of a skill proficiency by occupation model, etc. Accordingly, in some configurations, the learning engine 325 may develop one or more large language models (“LLMs”) 335. Generally, a LLM 335 may include a deep artificial intelligence (“AI”) or machine learning model (also referred to as language learning model) that can comprehend and generate human language text. For instance, a LLM 335 may be configured to determine meanings (or context) from a sequence of words and understand relationships between those words and, ultimately, perform a task based on that understanding. For instance, a LLM 335 may perform a variety of natural language processing (“NLP”) related tasks to produce content based on input prompts in human language. Such tasks may include answering questions (e.g., responding to a user query), translating text, text generation, content summary, sentiment analysis, entity extraction, entity or concept mapping or correlations, etc.

The LLM(s) 335 may be an artificial neural network that is trained using self-supervised learning, semi-supervised learning, or a combination thereof. Accordingly, in some configurations, the learning engine 325 may develop artificial neural networks using self-supervised learning, semi-supervised learning, or a combination thereof. In such configurations, the training data used by the learning engine 325 may be a large corpus of data, such as, e.g., data associated with or otherwise included in the skills ontology 125, the occupation taxonomy 130, the occupation database 135, domain expert feedback or data, etc. As illustrated in FIG. 3, the LLM(s) 335 may be stored in the model database 330 of the server 225. It should be understood, however, that, in some configurations, the LLM(s) 335 may be included in one or more separate devices accessible by the server 225 of FIG. 3 (including a remote database, and the like). In some configurations, the LLM(s) 335 may be trained (or retrained) using feedback data (as training data). For instance, in some configurations, the electronic processor 300 may receive data relating to domain expert review or feedback, as described in greater detail herein. In some configurations, such domain expert data may be implemented as training data (or feedback data), which may be utilized to retrain or update the LLM(s) 335 or other AI or machine learning models described herein.

As illustrated in FIG. 2, the memory 305 may include a skill proficiency application 340 (referred to herein as “the application 340”). The application 340 is a software application executable by the electronic processor 300 in the example illustrated and as specifically discussed below, although a similarly purposed module can be implemented in other ways in other examples. In some configurations, the application 340 may be a dedicated software application locally stored in the memory 305 of the server 225. As described in greater detail herein, the application 340 (when executed by the electronic processor 300) may enable or facilitate the skill proficiency framework described herein.

The memory 305 may include additional, different, or fewer components in different configurations. Alternatively, or in addition, in some configurations, one or more components of the memory 305 may be combined into a single component, distributed among multiple components, or the like. Alternatively, or in addition, in some configurations, one or more components of the memory 305 may be stored remotely from the server 225, or, in a remote database, another server, a remote user device, an external storage device, or the like.

Returning to FIG. 2, the system 200 may include the occupation database(s) 220. Although not illustrated in FIG. 2, the occupation database(s) 220 may include similar components as the server 225, such as electronic processor (for example, a microprocessor, an ASIC, or another suitable electronic device), a memory (for example, a non-transitory, computer-readable storage medium), a communication interface, such as a transceiver, for communicating over the communication network 250 and, optionally, one or more additional communication networks or connections, and one or more human machine interfaces.

The occupation database(s) 220 may store (or otherwise include) occupation data 255. The occupation data 255 may be specific to a particular occupation-related entity, such as, e.g., an employer entity, a recruiting entity, etc. In some instances, the occupation data 255 may included content related to a job opening with respect to a particular occupation entity. As one example, the occupation data 255 may include a job posting for an open job or position at an employer. In some instances, the occupation data 255 may include information or data related to a job or position, such as, e.g., an employer, a job title, a salary, a job description, employee benefits, a set of candidate or employee qualifications, a set of requisites of the job, a skill proficiency level, a working schedule, a start date, etc. The occupation data 255 may include various content types or formats (e.g., digital content). For instance, the occupation data 255 may include videos, audios, images, documents, posts, publications, etc. As one example, the occupation data 255 may include a job posting published on a recruitment agency's website, an employer's website, etc. As another example, the occupation data 255 may be published on a social media website as, e.g., a social media post.

As illustrated in FIG. 2, in some examples, the occupation database(s) 220 may be included within (or referred to as) a third-party data platform 260. The third-party data platform 260 may be maintained (or otherwise managed) by one or more third-party entities, such as, e.g., an occupation-related entity (e.g., an employer entity, a recruiting entity, etc.). In such configurations, the occupation database(s) 220 may be managed by an occupation-related entity, such as, the occupation-related entity that posted or published the job posting. Accordingly, in some configurations, the occupation database(s) 220 may include occupation data 255 for various occupation-related entities. For instance, the occupation data 255 may be associated with various data sources. In some examples, the system 200 includes a single instance of the occupation database 220. In such examples, the occupation database 220 may be implemented as a data warehouse or data lake, such that the occupation database 220 receives the occupation data 255 from various data sources, aggregates the occupation data 255, and stores the aggregated occupation data 255. Alternatively, or in addition, the system 200 may include multiple instances of the occupation database 220 (e.g., a first occupation database, a second occupation database, etc.). In such examples, each instance of the occupation database 220 may be associated with an occupation-related entity and may store) occupation data 255 for the associated occupation-related entity.

The system 200 may include the skills ontology database 230, the occupations taxonomy database 235, or a combination thereof. The skills ontology database 230 may store (or otherwise include) the skills ontology 125 of FIG. 1. The occupations taxonomy database 235 may store (or otherwise include the occupations taxonomy 130 of FIG. 1. Although not illustrated in FIG. 2, the skills ontology database 230 and the occupations taxonomy database 235 may include similar components as the server 225, such as electronic processor (for example, a microprocessor, an ASIC, or another suitable electronic device), a memory (for example, a non-transitory, computer-readable storage medium), a communication interface, such as a transceiver, for communicating over the communication network 250 and, optionally, one or more additional communication networks or connections, and one or more human machine interfaces.

The system 200 may also include the user device 205. The user device 205 may include a computing device, such as a desktop computer, a laptop computer, a tablet computer, a terminal, a smart telephone, a smart television, a smart wearable, or another suitable computing device that interfaces with a user. Although not illustrated in FIG. 2, the user device 205 may include similar components as the server 225, such as electronic processor (for example, a microprocessor, an ASIC, or another suitable electronic device), a memory (for example, a non-transitory, computer-readable storage medium), a communication interface, such as a transceiver, for communicating over the communication network 250 and, optionally, one or more additional communication networks or connections, and one or more human machine interfaces (HMIs). In some configurations, the functionality (or a portion thereof) as described as being performed by the server 225 may be locally performed by the user device 205. Alternatively, or in addition, in some configurations, the user device 205 may perform additional or different functionality than described herein. As one example, in some configurations, the functionality (or a portion thereof) as being performed by the server 225 may be performed by another component of the system 200, such as, e.g., the user device 205. In such configurations, the user device 205 may store at least one of, e.g., the application 340, the learning engine 325, the model database 330, or the like.

As illustrated in FIG. 2, the user device 205 may include a human machine interface (“HMI”) 265 for interacting with a user. The HMI 265 may include one or more input devices, one or more output devices, or a combination thereof. Accordingly, in some configurations, the HMI 265 allows a user to interact with (e.g., provide input to and receive output from) the user device 205. For example, the HMI 265 may include a keyboard, a cursor-control device (e.g., a mouse), a touch screen, a scroll ball, a mechanical button, a display device (e.g., a liquid crystal display (“LCD”)), a printer, a speaker, a microphone, or a combination thereof.

In the illustrated example of FIG. 2, the HMI 265 includes a display device 270. The display device 270 may be included in the same housing as the user device 205 or may communicate with the user device 205 over one or more wired or wireless connections. As one example, the display device 270 may be a touchscreen included in a laptop computer, a tablet computer, or a smart telephone. As another example, the display device 270 may be a monitor, a television, or a projector coupled to a terminal, desktop computer, or the like via one or more cables.

As illustrated in FIG. 2, the user device 205 may include a user application 275. The user application 275 is a software application executable by an electronic processor in the example illustrated and as specifically discussed below, although a similarly purposed module can be implemented in other ways in other examples. In some configurations, the user application 275 may be a dedicated software application locally stored in a memory of the user device 205. In some configurations, the user application 275 (when executed by an electronic processor) may enable or facilitate user interaction with the skills profile framework described herein. For instance, in some examples, the user application 275 may include (or otherwise provide functionality related to), e.g., the career pathway explorer applications 175, the workforce planning application 180, the job matching application 185, the curriculum design application 190, etc. As described in greater detail herein, in some configurations, a user may interact the user application 275 (e.g., via one or more user interfaces provided to the user by the user application 275) by viewing and interacting with the skill proficiency description(s) 140, the occupation-specific skill proficiency prerequisite(s) 145, the skill and occupation trend(s) 150, etc. (e.g., one or more outputs generated by the model layer 110).

As described herein, the skill proficiency framework may be utilized or implemented to generate skill proficiency descriptions. For example, for each skill, the technology disclosed herein may generate a set of proficiency descriptions that outline requisite capabilities at each proficiency level. In some configurations, the technology disclosed herein may implement (or utilize) a skill proficiency description generation pipeline to generate the set of proficiency descriptions. In some instances, the technology disclosed herein may further implement a validation process that validates the set of proficiency descriptions.

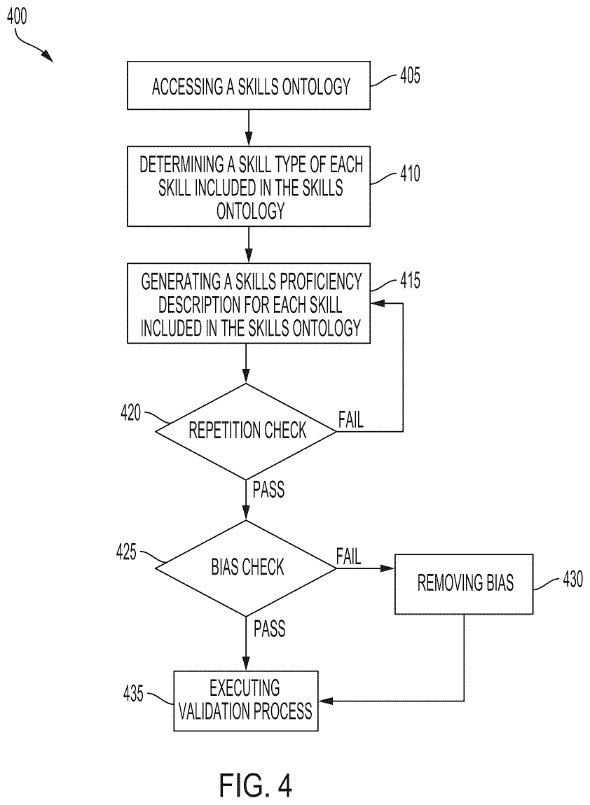

FIG. 4 illustrates a flowchart of an example method 400 to generate a set of proficiency descriptions according to some configurations. The method 400 is described as being performed by the server 225 and, in particular, the application 340 as executed by the electronic processor 300. However, as noted above, the functionality described with respect to the method 400 may be performed by other devices, such as, e.g., the user device 205, or distributed among a plurality of devices, such as a plurality of servers included in a cloud service.

As illustrated in FIG. 4, the method 400 may include accessing the skills ontology 125 (at block 405). As described herein, the skills ontology 125 may define (or otherwise include) a comprehensive list of standardized skills, knowledge, or abilities relevant to the workforce and education. In some examples, the skills ontology 125 may include transferable skills (e.g., communication, collaboration, etc.) or specialized skills (e.g., Python, geology, nursing, etc.). In some instances, each skill included in the skill ontology 125 may be associated with (or otherwise classified as) a specific skill type. A skill type may include, e.g., a knowledge-based skill type (e.g., anatomy, contract drafting, nursing, etc.), a personal attribute skill type (e.g., kindness, discretion, optimism, etc.), or a physical attribute skill type (e.g., physical stamina, kneeling, heavy lifting, navigating stairs, etc.).

In some configurations, the skills ontology 125 may be stored in the skills ontology database 230. In such configurations, the electronic processor 300 may access the skills ontology 125 from the skills ontology database 230. Alternatively, or in addition, in some configurations, the skills ontology 125 may be locally stored in the memory 305 of the server 22 In such configurations, the electronic processor 300 may access the skills ontology 125 from the memory 305.

After accessing the skills ontology 125 (e.g., at block 405), the electronic processor 300 may determine a skill type for each skill included in the skills ontology 125 (at block 410). For instance, the electronic processor 300 may perform a skill type differentiation based on the skills ontology 125.

For instance, some skills follow a typical learning curve where ability and knowledge progressively build in depth and complexity. For such skills (e.g., knowledge-based skill types), the technology disclosed herein may implement five proficiency levels: a Beginner level, an Advanced Beginner level, a Competent level, a Proficient level, and an Expert level. As one example, communication skills at the Beginner level involves understanding and following simple verbal and written instructions, and expressing thoughts and ideas clearly in one-on-one conversations, while at the Proficient level, communication skills involve the ability to facilitate group discussions, excel in active listening, and provide constructive feedback. As another example, for a more technical skill, Microsoft Excel, at the Beginner level involves understanding the basic layout of Excel, including, e.g., cells, rows, columns, and worksheets, and performing simple calculations, the Competent level involves the ability to create complex formulas, pivot tables, and charts, and the Proficient level involves use of advanced functions, such as, e.g., VLOOKUP and IF statements.

Skills related to personal attributes (e.g., Kindness, Discretion, Optimism, etc.) and physical skills (e.g., Physical Stamina, Kneeling, Heavy Lifting, etc.) cannot be aligned to a standard learning progression. While aptitude in these skills can be developed, proficiency does not rely on incremental gains in knowledge. For these skills, a general description of expectations in a workplace are given. For example, some of the requisites of Honesty include “demonstrating integrity by being truthful in all interactions, utilizing effective communication skills” or “taking responsibility for actions, admitting mistakes, demonstrating self-awareness and emotional intelligence.”

Accordingly, in some instances, the electronic processor 300 may determine whether a skill of the skill ontology 125 is a knowledge-based skill type, a personal attribute skill type, or a physical attribute skill type.

In some configurations, the electronic processor 300 may then perform prompt development such that, for each skill included in the skill ontology 125, a prompt is designed for proficiency description generation. The electronic processor 300 may develop (or generate) a prompt based on a skill type of the skill for which the prompt is developed for. For instance, whether a skill is a knowledge-based skill type, a personal attribute skill type, or a physical attribute skill type may impact development of the prompt. For example, as noted above, skills classified as personal attribute skill types and physical attribute skill types cannot be aligned to a standard learning progression while skills classified as knowledge-based skill types can be aligned to a standard learning progression. Therefore, by differentiating between skills that follow a typical learning curve and those skills that do not, the electronic processor 300 may develop prompts that are optimized or improved for specific skill types.

In some configurations, the electronic processor 300 may develop prompts for proficiency description generation iteratively for different skill types to ensure the quality and consistency of results across skills. Each prompt may include an identifier of the corresponding skill (e.g., a name of the target skill), a description of the skill, one or more gold standard examples, etc. In some configurations, the electronic processor may develop the prompts such that the prompts request that any related skills and knowledge are mentioned in the generated skill proficiency descriptions, which may allow for the identification of interconnected learning pathways to assist users in targeted upskilling. For example, during conversations, communication skills may be broadly used, which can encompass listening skills, body language, empathy, negotiation, etc. The skill proficiency descriptions may identify such skills in order to, e.g., aid in targeted upskilling (e.g., learning related skills can improve proficiency in a target skill). As one example, learning about the pasteurization can improve a user's proficiency in that user's target skill of cheese making (e.g., “Understands the principles of pasteurization and its role in cheese making.”-Cheese Making at the Advanced Beginner level).

In some configurations, the prompt(s) may ensure that the skill proficiency description(s) are inclusive of multiple individuals in the workforce. For example, the prompts may be agnostic to gender, culture, country, workplace, etc. The prompts may be inclusive of users having different abilities. For example, more generic words such as “move” and “travel” may be considered more inclusive than “carry” and “walk,” respectively, (unless such movements are absolute requisites for the skill).

In some configurations, the prompts may be utilized as LLM queries (or LLM requests). For instance, in some configurations, the electronic processor 300 may provide a prompt to the LLM 335 (as an LLM query). In some examples, the electronic processor 300 may run (or execute) a LLM query for the prompt. The LLM 335 may provide (or otherwise generate) a skills proficiency description (as an LLM response or output).

Accordingly, as illustrated in FIG. 4, the electronic processor 300 may generate a skill proficiency description for each skill included in the skills ontology (at block 415). As described herein, each skill proficiency may be specific to a respective skill and a corresponding proficiency level of the respective skill. As one example, when a skill has three proficiency levels, the electronic processor 300 may generate three skill proficiency descriptions, including, e.g., a first skill proficiency description for a first proficiency level of the skill, a second skill proficiency description for a second proficiency level of the skill, and a third skill proficiency description for the third proficiency level of the skill.

The skill proficiency description may indicate a corresponding requisite associated with performance of the respective skill at the corresponding proficiency level. A requisite may indicate a capability or skill that is necessary for an achievement of a specified end (e.g., a capability to performance of a skill at a particular proficiency level). As one example, when the skill is Python and the proficiency level is a Beginner level, the skill proficiency description may indicate, as requisite(s), one or more capabilities or tasks, such as, e.g., data types, variables, loops, etc., that a beginner level Python user is expected to be able to perform. As another example, when the skill is Python and the proficiency level is a Competent level, the skill proficiency description may indicate, as requisite(s), one or more capabilities or tasks, such as, e.g., object-oriented programming, data structures, algorithms, etc., that a competent level Python user is expected to be able to perform.

In some configurations, the electronic processor 300 may perform one or more verification or validation processes with respect to the skill proficiency description(s). The verification or validation processes may include, e.g., a vocabulary diversification verification process to verify that a given skill proficiency description uses diverse vocabulary or otherwise is not repetitive relative to another skill proficiency description (e.g., checks for repetition among skill proficiency descriptions), a bias verification process to verify that a given skill proficiency description is free from bias, or a validation process that involves domain expert feedback of the skill proficiency description(s).

For instance, as illustrated in FIG. 4, in some configurations, after generating the skill proficiency description(s) (e.g., at block 415), the electronic processor 300 may execute a vocabulary diversification verification process to determine whether the skill proficiency description(s) satisfies a repetition condition (also referred to herein as a language diversity condition) (at block 420). The language diversity condition may be used to verify that the skill proficiency description(s) uses diverse vocabulary (e.g., relative to other skill proficiency descriptions), such that, the skill proficiency description(s) is not repetitive.

For instance, each proficiency level may have a finite number of skill proficiency descriptions. As such, the skill proficiency description(s) may be checked to confirm that the skill proficiency description(s) are informative and explicitly outlines the requisite capabilities. When the skill proficiency descriptions exhibit too much similarity, such as consistently starting with words like “can” or “able to,” distinguishing between proficiency levels may become challenging. Execution of the vocabulary diversification verification process may address (or mitigate) this issue. For example, in some configurations, the electronic processor 300 may perform a regular expression search (e.g., a regex search). A regex search may be a searching technique that identifies specific patterns within text strings. The electronic processor 300 may perform the regex search in order to identify patterns within the skill proficiency description(s) that are indicative of repetition. For example, the electronic processor 300 may perform the regex search to identify how many skill proficiency descriptions begin with the same verb. To ensure diversity in vocabulary usage, the electronic processor 300 may flag (or otherwise indicate) any frameworks containing five or more skill proficiency descriptions starting with the same verb (e.g., as a language diversity condition). When a framework is flagged as not satisfying the language diversity condition, the electronic processor 300 may facilitate modifying (or re-generating) the skill proficiency descriptions included within that framework such that the skill proficiency descriptions utilize a broader range of vocabulary (e.g., by initiating the skill proficiency descriptions with various verbs). In some examples, the electronic processor 300 may utilize the LLM 335 to modify the skill proficiency descriptions, e.g., by providing a new prompt to the LLM 335, where the new prompt requests a broader range of vocabulary with respect to verb usage.

Accordingly, as illustrated in FIG. 4, when the language diversity condition is not satisfied (e.g., FAIL at block 420), the method 400 may return to block 415. When the language diversity condition is satisfied (e.g., PASS at block 420), the method 400 may continue to block 425, as illustrated in FIG. 4.

As illustrated in FIG. 4, in some configurations, the electronic processor 300 may execute a bias verification process to determine whether the skill proficiency description(s) satisfies a bias condition (at block 425). For instance, the bias verification process may be utilized in order to determine whether the skill proficiency description(s) include bias. The bias condition may be used to verify that the skill proficiency description(s) are not biased. The bias condition may include one or more rules, indicators, or conditions for identifying bias. In some configurations, the bias condition may be based on, e.g., an inclusivity guidelines or standards, such as, e.g., a guideline outlining conventions on appropriate language usage.

Bias in skill proficiency descriptions can impact fairness and accuracy. Subjective judgments from those creating the framework can introduce personal biases, leading to skewed descriptions that favor specific groups. Additionally, the use of exclusive language can alienate individuals from underrepresented groups. Such biases in the skill proficiency descriptions can result in unfair assessments, perpetuate inequalities, or fail to accurately capture the true abilities and potential of diverse individuals.

Accordingly, in some configurations, to ensure that the skill proficiency descriptions are free from bias, the electronic processor 300 may implement a two-step process to identify and rectify any potential biases of the skill proficiency descriptions. The electronic processor 300 may instruct the LLM 335 to identify any skill proficiency descriptions that may fail to satisfy the bias condition and to remove any identified biases. The electronic processor 300 may then facilitate a regex search to flag any skill proficiency descriptions containing words that could be considered biased or exclusive (e.g., use of pronouns, such as “he” or “she”). Accordingly, in some configurations, the bias condition may include a blacklist of words considered biased or exclusive.

Accordingly, as illustrated in FIG. 4, when the bias condition is not satisfied (e.g., FAIL at block 425), the electronic processor 300 may facilitate removal of any biases included in the skill proficiency description(s) (at block 430). When the bias condition is satisfied (e.g., PASS at block 425), the method 400 may continue to block 435, as illustrated in FIG. 4.

As illustrated in FIG. 4, in some configurations, the electronic processor 300 may execute a validation process to validate the skill proficiency description(s) (at block 425). The electronic processor 300 may validate the skill proficiency description(s) to ensure accuracy and consistency with work-place expectations.

In some configurations, the electronic processor 300 may determine whether the skill proficiency descriptions align to course descriptions. For instance, the electronic processor 300 may compare the skill proficiency description(s) to course description(s) to assess whether the frameworks broadly cover the material in the correct order. For example, based on the course description(s), the skill proficiency descriptions for the Python (e.g., the skill) at the Beginner level (e.g., as a first proficiency level of the skill) should encompass basic concepts such as data types, variables, and loops, while the Competent level (e.g., as a second proficiency level of the skill) should include more advanced topics like object-oriented programming, data structures, and algorithms. When the skill proficiency description(s) align with course description(s), the electronic processor 300 may validate the skill proficiency description(s). When the skill proficiency description(s) do not align with course description(s), the electronic processor 300 may not validate the skill proficiency description(s).

Alternatively, or in addition, the electronic processor 300 may compare the skill proficiency description(s) to existing (or preexisting) frameworks. For instance, the electronic processor 300 may compare one or more of the skill proficiency descriptions for a first framework to one or more skill proficiency descriptions for a preexisting framework. Accordingly, in some configurations, frameworks may be compared against existing frameworks for a selection of skills. For example, skill proficiency descriptions related to communication may be compared against a Personal and Social Capabilities (PSC) Frameworks for communication, collaboration, and self-management. The PSC frameworks may look at the development of skills from pre-school to adulthood, providing a condensed view of workplace-relevant components. The overall comparison may reveal overlap in the included content, particularly at higher PSC levels more closely related to the workplace. However, some competencies described at the lower PSC levels such as “[using] basic techniques to signal lack of understanding” and “[inferring] the meaning of unfamiliar words from the message” may not be included in the generated skill proficiency descriptions. In some instances, these competencies may be considered too fine-grained and foundational for inclusion in a framework focused at the workplace level. When the skill proficiency description(s) align with preexisting framework(s), the electronic processor 300 may validate the skill proficiency description(s). When the skill proficiency description(s) do not align with preexisting framework(s), the electronic processor 300 may not validate the skill proficiency description(s).

Alternatively, or in addition, the electronic processor 300 may receive domain expert review feedback related to the skill proficiency description(s). In some instances, the skill proficiency description(s) may be presented or otherwise provided for further validation by domain experts. Domain experts may interact with (e.g., view, edit, provide feedback or commentary, etc.) the skill proficiency description(s) for various skills and proficiency levels. For instance, the domain experts may review and validate the skill proficiency description(s). In some instances, skill proficiency statements flagged, by the domain experts, as potentially biased, exclusive, or inappropriate may be manually reviewed and edited in the subsequent iteration of the pipeline. When the skill proficiency description(s) are validated by domain experts (based on the domain expert review feedback), the electronic processor 300 may validate the skill proficiency description(s). When the skill proficiency description(s) are not validated by domain experts (based on the domain expert review feedback), the electronic processor 300 may not validate the skill proficiency description(s).

Accordingly, in some configurations, the electronic processor 300 may validate the skill proficiency description(s) (e.g., at block 435) based on an alignment to course descriptions, a comparison to existing frameworks, domain expert review feedback, or a combination thereof.

In some configurations, the electronic processor 300 may store the skill proficiency description(s) in the memory 305 such that the skill proficiency description(s) are accessible. In some configurations, the electronic processor 300 may store the skill proficiency description(s) such that each skill proficiency description is associated with a corresponding skill and a respective proficiency level of that skill.

As described herein, the technology disclosed herein may determine (or otherwise provide) occupation-specific skill proficiency requests. For instance, when a skill is applied to complete a task at work, a certain proficiency level is often a prerequisite in that skill to achieve the requisite outcome. By providing a metric for the proficiency requisite for different occupations, at various seniority levels thereof, the technology disclosed herein may: identify users with the best talent to fill a role through hiring or internal mobility; develop targeted personal development plans that highlight incremental progress; or benchmark organizations' workforces to identify strengths and weaknesses to plan for the future.

Requisites for an occupation are not static; such requisites change in response to the adoption of new technologies, the introduction of regulations, or shifts in the availability and popularity of products. Understanding these changes allow individuals to effectively plan their career pathways, managers to implement relevant training programs, and organizations to strategically manage talent and adapt to evolving environments. The technology disclosed herein allows such changes to be readily captured and provides guidelines for new skills that emerge on the market. Accordingly, the technology disclosed herein provides a skill proficiency by occupation model. The skill proficiency by occupation model may utilize large-scale occupation data (e.g., job posting or ad data) to determine the current proficiency requisites for different occupations, at a particular designation or seniority level.

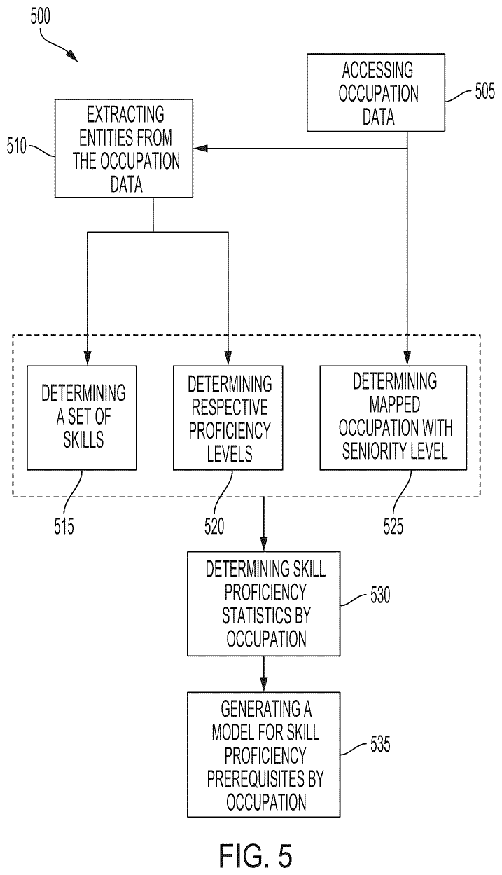

FIG. 5 illustrates a flowchart of an example method 500 to generate a model mapping skill proficiency by occupation (also referred to herein as the skill proficiency by occupation model) according to some configurations. The method 500 is described as being performed by the server 225 and, in particular, the application 340 as executed by the electronic processor 300. However, as noted above, the functionality described with respect to the method 500 may be performed by other devices, such as, e.g., the user device 205, or distributed among a plurality of devices, such as a plurality of servers included in a cloud service.

As illustrated in FIG. 5, the method 400 may include accessing the occupation data 255 (at block 505). As described herein, the occupation data 255 may include content or information related to a job opening. For instance, the occupation data 255 may include a job posting, where the content of the job posting includes information related to the job or occupation (e.g., a job description). For instance, the job posting may include, e.g., an employer, a job title (e.g., a seniority level or a designation), a salary, a job description, employee benefits, a set of candidate or employee qualifications, a set of requisites of the job (or occupation), a skill proficiency level, a working schedule, a start date, etc. The occupation database(s) 220 may store (or otherwise include) the occupation data 255. Accordingly, in some configurations, the electronic processor 300 may access the occupation data 255 from the occupation database(s) 220. Alternatively, or in addition, the occupation data 255 may be stored locally in the memory 305 of the server 225. In such configurations, the electronic processor may access the occupation data 255 from the memory 305.

The electronic processor 300 may extract one or more entities from the occupation data 255 (at block 510). As used herein, an entity extracted from the occupation data 255 may include, e.g., a skill, a proficiency level of a skill, or a combination thereof. For example, the electronic processor 300 may extract, from the occupation data 255, a skill and a respective proficiency level of the skill (as an extracted entity).

The electronic processor 300 may determine a set of skills indicated by the occupation data 255 (at block 515). In some configurations, the electronic processor 300 may determine the set of skills based on the one or more entities extracted from the occupation data 255. For instance, in some configurations, the one or more entities extracted from the occupation data 255 may include the set of skills (e.g., an entity extracted from the occupation data 255 is a skill). In some configurations, the set of skills indicated by the occupation data 255 may be included in the skill ontology 125, as described herein. In some examples, the electronic processor 300 may implement a named entity recognition (NER) model to identify skill entities in the occupation data 255. The identified skill entities (e.g., the set of skills) may then be mapped to the skills in the skill ontology 125.

The electronic processor 300 may determine a set of proficiency levels for the set of skills (at block 520). For instance, the electronic processor 300 may determine, for each skill included in the set of skills (e.g., determined at block 515), a respective proficiency level for that skill. Accordingly, in some configurations, each skill of the set of skills may be associated with a respective proficiency level (of the set of proficiency levels).

The electronic processor 300 may determine an occupation having a corresponding designation from the occupation data (at block 525). As used herein, a designation may represent, e.g., a seniority level or title. For example, a designation may include, e.g., junior, mid-level, senior, lead, etc. In some configurations, the electronic processor 300 may determine the occupation based on (or using) the occupations taxonomy 130. For instance, in some configurations, the electronic processor 300 may map each job posting (e.g., the occupation data 255) to an occupation included in the occupations taxonomy 130. In some configurations, the electronic processor 300 may map each job posting to an occupation included in the occupations taxonomy 130 using a supervised matching model. The supervised matching model may be developed (or trained) with golden standards defined by domain experts as training data.

In some configurations, the electronic processor 300 may implement a keyword-based approach to extract the entities (e.g., the set of skills, the set of proficiency levels for the set of skills, an occupation, a designation for the occupation, etc.) from the occupation data 255. For instance, occupation data 255 including: “extensive working experience with Python,” indicates a higher proficiency level than occupation data 255 including: “basic knowledge of Python.”

In some configurations, after preprocessing, including n-grams generation, the electronic processor 300 may assign each skill indicated by the occupation data 255 a respective proficiency level based on, e.g., the preceding keywords. In some instances, the highest proficiency level requested for a skill in the occupation data 255 may represents the desired proficiency level, as the emphasis on the actual proficiency requisite may be given primarily in one mention, with further re-mentions just used to reinforce the importance of the skill. For example, a job posting asking for Microsoft Office skills may first mention the skill in the context of broader work responsibilities, such as, e.g., “experience with Microsoft Powerpoint and the MS Office suite for preparing communications to stakeholders” and then later in the job posting mention “strong MS Office skills”.

In some configurations, keywords to identify proficiency levels may be selected based on the most common words describing proficiency levels in the extracted entities. For a random sample of N skill entities per keyword, the skill entity, job ad occupation, skill, and descriptions from the skill ontology 125 or the occupation taxonomy 130 (included to ensure consistent interpretation) may be provided to the LLM 335. The electronic processor 300 may compare the average proficiency level suggested by the LLM 335 to the assigned keyword proficiency level to ensure accurate categorization. Any mismatches in proficiency scores may be manually reviewed and corrected.

In some configurations, the electronic processor 300 may implement a statistical model to determine skill proficiency statistics by occupation (at block 530). The proficiency level of a requisite skill for a given occupation is not a singular value. Rather, the proficiency level of the requisite skill for a given occupation varies across job postings (e.g., across subsets of the occupation data 255). As one example, a Business Analyst job posting may request Project Management proficiency at different levels depending on the company, industry, or seniority level (e.g., designation). Therefore, the electronic processor 300 may implement a statistical model to determine (or otherwise provide) statistics on the requisite proficiency levels for each skill within an occupation, rather than a single value (e.g., a single proficiency level).

In some configurations, the electronic processor 300 may extract the proficiency levels mentioned in job postings (e.g., the occupation data 255), aggregate the proficiency levels, and determine summary statistics to determine the proficiency requisites for each skill across different occupations. In some configurations, the electronic processor 300 may determine the mean, the median, or the standard deviation of the proficiency levels, derived from job postings within a time window (e.g., a 12-month sliding window). Deriving the proficiency levels from job postings within the time window (e.g., the 12-month sliding window) may ensure that the data remains current and reflects the latest market trends. Additionally, in some configurations, the electronic processor 300 may determine a percentage of job postings that mention each skill, which may indicate the ranking or priority of the skill for the occupation. In some configurations, the electronic processor 300 may determine a distribution of proficiency levels for each skill per occupation, which may provide a more nuanced view of the requisites. In some configurations, the proficiency data may be further stratified by seniority level (or designation), which may enable generation of summary statistics specific to different seniority tiers (or designations) within each occupation.

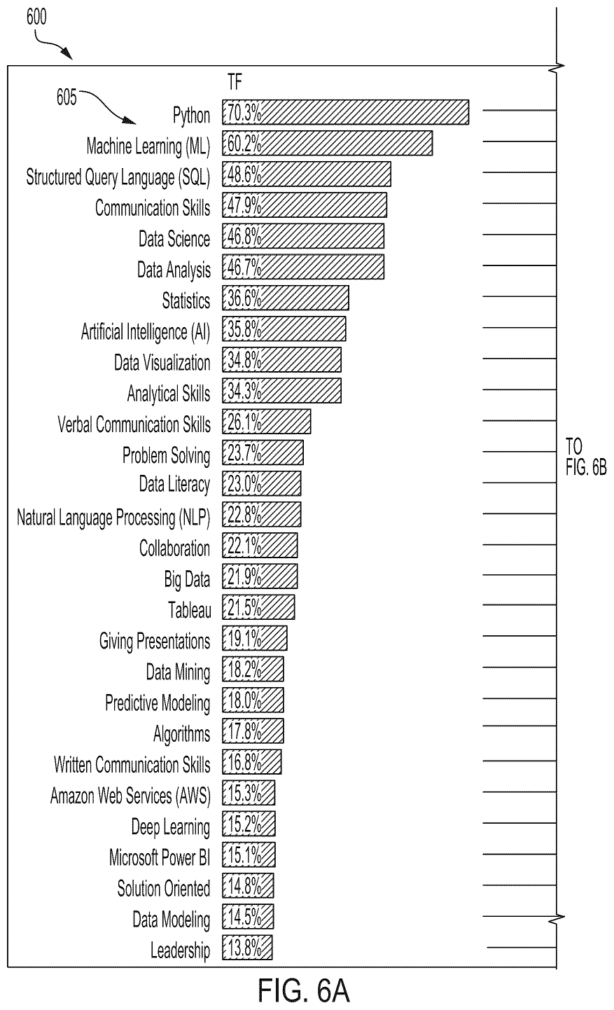

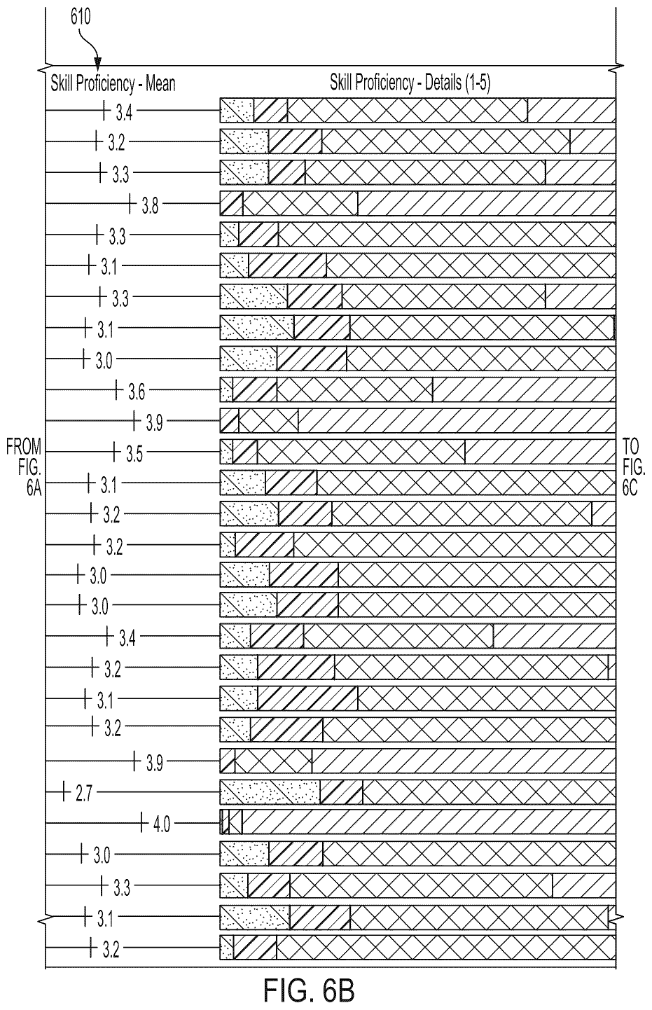

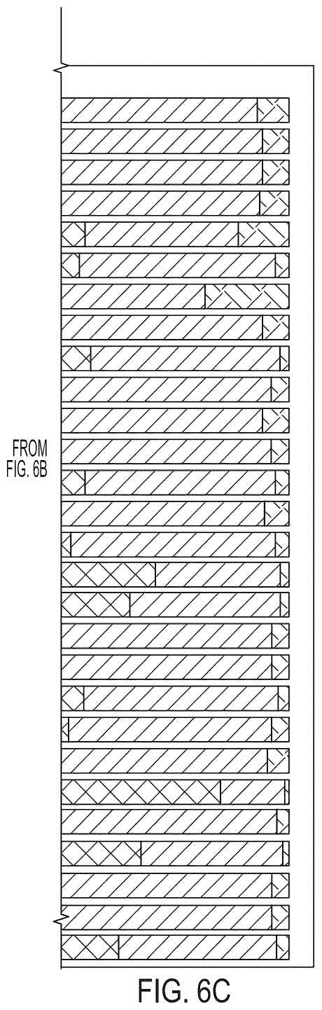

For example, FIGS. 6A-6C illustrate a graph 600 illustrating statistics related to a data scientist. As illustrated in FIGS. 6A-6C, the graph 600 includes a plurality of skills associated with a data scientist (represented by reference numeral 605). The graph 600 also includes various statistics related to each of the skills. For instance, the graph 600 indicates a skill proficiency mean statistic for each skill (represented by reference numeral 610).

In some configurations, the electronic processor 300 may perform post-processing and anomaly detection process, such as, e.g., with respect to the skill proficiency statistics by occupation (e.g., as determined at block 530). For instance, in an occupation, there is a general assumption that more senior roles build upon skills required for more junior roles, with the proficiency requisite in these skills increasing or remaining consistent. Job postings for higher seniority roles often emphasize leadership or more advanced technical skills and may not list basic skills (e.g., Basic Mathematics or Microsoft Excel for a Lead Data Analyst) assumed to be possessed by individuals. Consequently, many core skills lack data for higher seniority levels (or designations). To address this, the electronic processor 300 may use proficiency scores from more junior levels to impute proficiency scores at higher seniority levels, where such proficiency scores represent the minimum requisite (e.g., as part of a post-processing process). Alternatively, or in addition, in some configurations, the electronic processor 300 may detect anomalies. For instance, in some configurations, the electronic processor 300 may detect or flag low-confidence results as potentially anomalous. Low-confidence results that the electronic processor 300 may flag as potentially anomalous may include, e.g., results having a zero standard deviation (e.g., all job postings for that occupation/skill combination have the same proficiency level), results having over 95% of job postings lacking proficiency scores (e.g., indicating missing important proficiency information), or results having data points failing a significance test.

As illustrated in FIG. 5, the electronic processor 300 may generate a model for skill proficiency prerequisites by occupation (e.g., the skill proficiency by occupation model) (at block 535). As described herein, the skill proficiency by occupation model may correlate each occupation, having a corresponding designation, to a skill proficiency description that indicates a requisite associated with performing a skill of the occupation at a respective proficiency level. For example, the model may include a first occupation having a corresponding designation (or seniority level). The model may correlate the first occupation with a skill proficiency description that was generated for a skill and a respective proficiency level of that skill.

In some configurations, the electronic processor 300 may perform a validation process of the skills proficiency by occupation model. For instance, occupation skill proficiency scores that accurately reflect workplace expectations and that effectively high-light skill gaps between occupations are desirable. When assessing skill proficiency, the requisites of one occupation relative to another occupation may be compared. For example, a Software Engineer is expected to have higher proficiency in Computer Programming compared to an Accountant, whereas an Accountant is assumed to be better at Financial Reporting. The relative ranking of occupation/skill pairs by proficiency can be utilized to evaluate alignment in proficiency expectations across datasets with varying methodologies for scoring skills. In some implementations, the skill proficiency scores described herein may be compared against other approaches for measuring proficiency requisites.

As one example, the skill proficiency scores described herein may be compared (or benchmarked against) O*NET attributes. Occupation skill proficiency scores may be benchmarked against data from the Occupational Information Network (O*NET). O*NET surveys workers in the United States to establish the importance of a set of occupational attributes, including knowledge (e.g., Economics and Accounting, Chemistry), skills (e.g., Programming, Repairing), abilities (e.g., Oral Comprehension, Problem Sensitivity), etc. Out of the 244 O*NET attributes, 29 were identified as directly aligning with the skills included in the skills ontology 125 as described herein. The O*NET and proficiency scores were standardized, and differences in relative score are compared. A total of 1,022,527 occupation/skill pairs were identified in the O*NET data that showed differences in workplace expectations (based on a difference in score of more than 0.5). Of these pairs, 907,173 (88.8%) had the same rank order as the skill proficiency data.

There is a high level of alignment, but some differences are present due to differences in methodology and data sources. For example, O*NET gives relatively low scores to Conservation Scientists and Critical Care Nurses for Public Speaking (2.55 and 2.79 respectively). In contrast, the proficiency data implemented by the technology disclosed herein assigns much higher scores (3.59 and 4.18, respectively), which accurately reflects the emphasis placed on this skill and communication skills more broadly for these occupations in the analyzed job ads.

O*NET data, based on surveys, updates less frequently and may not capture current job market trends influenced by evolving roles, new technologies, specific industry trends, and skill availability. O*NET surveys also cover a limited subset of the workforce, whereas skill proficiency data derives from a larger dataset of job postings spanning various industries and roles. However, job postings are tailored to immediate hiring needs and may not encompass the full spectrum of requisite skills for a role. For example, O*NET indicates the Bioinformatics Scientists require equivalent to an expert level in Biology. Job postings for Bioinformatics Scientists mention Biology but focus more on the niche requisite skills and tend not to emphasize general biology knowledge, hence this is only indicated as Competent in the skill proficiency data. Conversely, the skill proficiency data for Bioinformatics Scientists includes additional relevant skills like Deep Learning, Computer Science, and Cell Signaling, providing detailed insights into role requisites beyond the general Biology knowledge/skill.

As another example, the skill proficiency scores described herein may be compared (or benchmarked against) top mentioned skills. In each occupation there are specific skills that are more relevant for performing the job effectively. The technology disclosed herein may score skills based on the frequency at which the skills are mentioned in job postings to identify what are currently the most important skills for each occupation. In many cases, it may be assumed that skills that are important in occupations may also expected to be performed at higher proficiency levels. There may be some exceptions to this such as in occupations where technology is used to augment skills, precluding the need for higher skill proficiency.

The technology disclosed herein may select the top 100 skills by importance for each occupation and then compare the relative rank of occupation/skill pairs. The importance scores may be standardized relative to the means and rescaled to a range of 0 to 1. Validation may be conducted on occupation/skill pairs where there is a difference of more than 0.5 points in importance scores, indicating disparities in expectations. Overall, 123,771 out of 183,988 occupation/skill pairs (66.6%) exhibit the same rank order as the skill proficiency data.

These results indicate that there is fairly good alignment between the skill importance and skill proficiency data. Complete alignment is not expected as how frequently a skill is mentioned in job postings and actual importance of the skill to a role does not always translate directly to the proficiency requested in a job posting. Occupations that commonly offer on-the-job training often mention key skills frequently but may request quite low levels of skill proficiency in job postings as the skill proficiency gap is filled post-hire. For example, for Helpers of Roofers, Roofing is a key and very frequently mentioned skill but individuals in these roles are assisting Roofers and are not expected to be experts in this skill. The skill proficiency by occupation model recommends that Helpers of Roofers have a Competent level of proficiency for this skill which is more in-line with expectations than suggested by skill importance alone.

Another perspective for comparing skill proficiency expectations may include through the lens of seniority or leadership responsibilities within a role. It is generally assumed that skill proficiency in core occupational skills increases as individuals progress from junior to senior roles and eventually into leadership positions. Transitions to leadership roles often entail changes in occupations, bringing with them distinct tasks, skills, and objectives. Nevertheless, these leaders are expected to maintain a high level of proficiency in many core occupational skills. To explore this, the hypothesis that, on average, managerial roles should have comparable or higher skill proficiency scores than the equivalent individual contributor (IC) occupation may be tested. A total of 676 ranked skill comparisons were made across 73 unique manager/IC role combinations. Overall, 461 (68.2%) of the occupation/skill pair comparisons showed higher proficiency scores for the managerial role than the IC role. These results demonstrate that in general the skill proficiency by occupation model is generally in-line with leadership expectations. However, managerial job ads may not emphasize skills that are assumed from the presumed progression from an IC role. For example, Digital Marketing Specialists at the IC level are recommended a Competent level of proficiency in Internet Research, while the managerial role is only placed at an Advanced Beginner level. A manager in this role may not utilize this skill as often day-to-day as the IC role but they are likely still expected to have a similar or greater proficiency in this skill. Some of the identified discrepancies, however, reflect expected differences in proficiency, such as IC roles with specialized skills that are not expected in a more generalist manager role. For example, for job postings requesting Revenue Analysis, Data Scientists are expected to have a Competent level of proficiency while Data Science Managers are only expected to have a Novice level.

In some configurations, the technology disclosed herein may provide an interactive visualization system or platform. In some configurations, the interactive visualization system may be a software application, such as, e.g., the user application 275 of FIG. 2. Alternatively, or in addition, the interactive visualization system or platform may be provided or hosted via the server 225 (e.g., as a cloud service). In some configurations, the interactive visualization system may be executed by an electronic processor of the user device 205. The interactive visualization system (when executed by an electronic processor) may enable or facilitate user interaction with the skills profile framework described herein. For instance, in some examples, the interactive visualization system (when executed by an electronic processor) may generate (or provide) one or more user interfaces (or graphical user interfaces) for display via the display device 270 of the user device 205. As described herein, the user device 205 may be used by a user to interact with the skills profile framework described herein, including, e.g., the skill proficiency descriptions, the skill proficiency by occupation model, the skill proficiency statistics by occupation, etc. For instance, the interactive visualization system may provide a user with insights related to one or more of the following inquiries: (a) given one's current job, what are their potential career paths? (b) What if they would like to switch to a different career? (c) what is the skill gap between their current and target job? or (d) how can they address the skill gap? Such insights may be based on, e.g., the skill proficiency descriptions, the skill proficiency by occupation model, the skill proficiency statistics by occupation, etc., as described herein.

In some configurations, the interactive visualization system may be configured to provide (when executed by an electronic processor) one or more views: (a) a career pathways view; (b) a skill gap view; or (c) a skill proficiency view. In some configurations, the career pathways view, the skill gap view, and the skill proficiency view are coordinated. The interactive visualization system may display one or more of the views simultaneously. For example, the interactive visualization system may display each view at the same time, where each view is provided view a panel or segment of a main user interface of the interactive visualization system. In such instances, a user may interact with (or view) content provided by each view simultaneously (at substantially the same time). Alternatively, or in addition, in some configurations, each view may be an individual window or user interface of the interactive visualization system (e.g., separate and distinct windows or user interfaces).

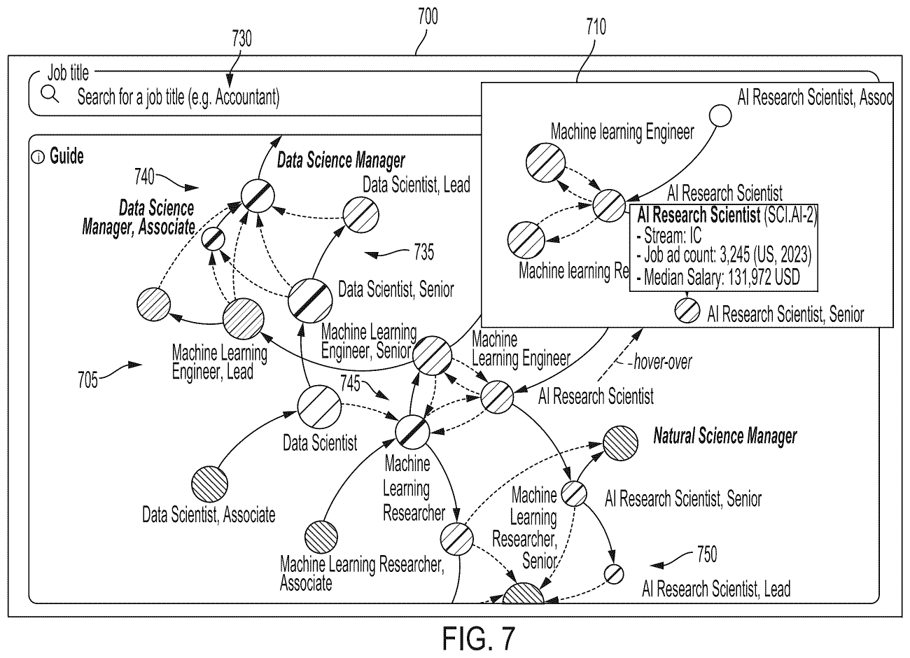

FIG. 7 illustrates an example career pathways user interface 700 that represents the career pathways view of the interactive visualization system in accordance with some configurations. As illustrated in FIG. 7, the career pathways user interface 700 may include a directional node-link diagram 705 of a career pathway. As illustrated in FIG. 7, each node of the directional node-link diagram 705 may represent an occupation and each directional edge may represent a transition between a first occupation and a second occupation. As illustrated in FIG. 7, the directional node-link diagram 705 provides a visual representation of a hierarchical structure of the career pathway. Additionally, the directional node-link diagram 705 provides a visual mapping of continuous transitions between multiple occupations (e.g., the continuous transitions from a first occupation to a second occupation, and then to a third occupation). In some configurations, to enhance readability, a force-directed layout may be utilized to minimize edge crossings. Alternatively, or in addition, the career pathway may be visually represented using a matrix view, where rows and columns represent the source occupation title and the target occupation titles, respectively, and the cells indicate the transitions.

In some instances, various characteristics or metrics associated with each occupation may be represented via a display property of the node(s), the edge(s), or a combination thereof. As one example, a diverging color scheme may be utilized to represent a salary range, with a first color (e.g., green) indicating a higher salary and a second color (e.g., orange) indicating a lower salary compared to a user's current occupation. As another example, different line types (e.g., solid, dashed, dotted, etc.) may denote different transition types (e.g., career progression to management and career switch). As yet another example, a size property of a node may represent a job count (e.g., a larger sized node may represent a higher job count while a smaller sized node may represent a lower job count). As yet another example, a weight property (or thickness property) of an edge (e.g., 10 pt. or 24 pt.) may represent a transition probability between two occupations (e.g., a thicker edge may indicate a greater transition probability while a thinner edge may indicate a lesser transition probability).

In some configurations, when a user interacts with a node or an edge of the directional node-link diagram 705, the interactive visualization system (e.g., an electronic processor executing the interactive visualization system) may provide additional information, such as, e.g., in a pop-up window. For example, as illustrated in FIG. 7, responsive to detecting a user interaction with (e.g., a mouse click or a hover interaction), the electronic processor 300 may generate and provide a pop-up window 710. In the illustrated example, the pop-up window 710 may include additional information related to an artificial intelligence (AI) research scientist, including, e.g., an associated stream (e.g., IC), a job posting count, a median salary, etc.

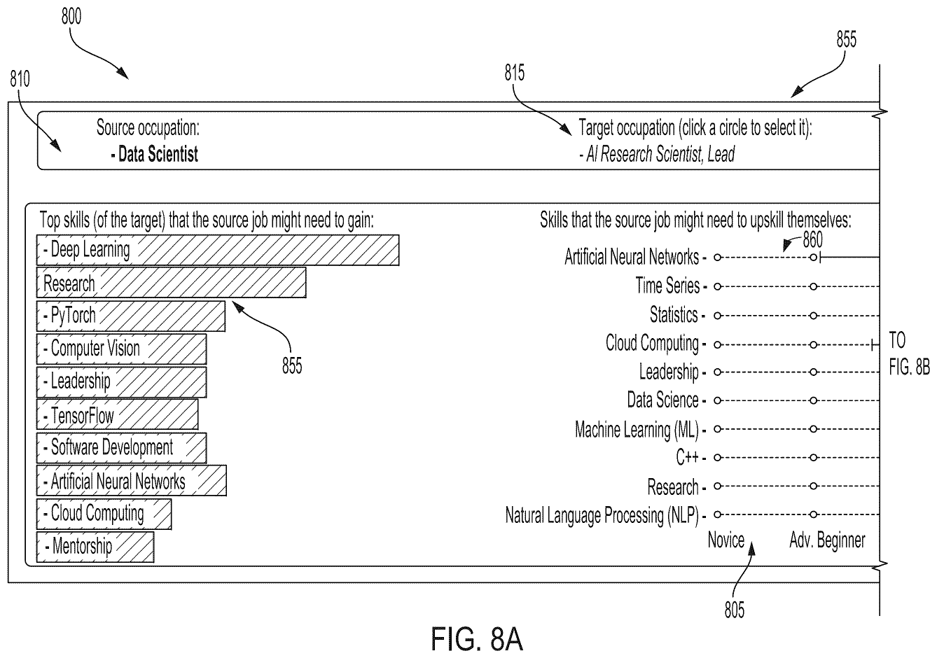

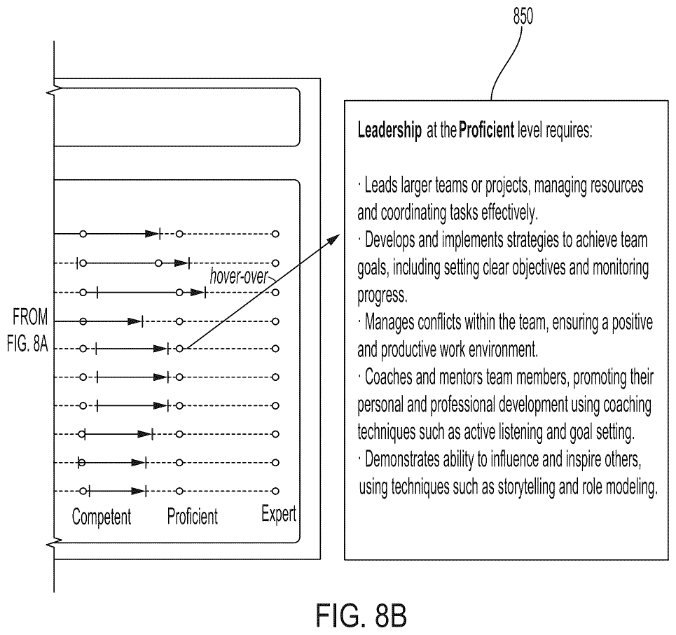

FIGS. 8A-8B illustrate an example skill gap user interface 800 that represents the skill gap view of the interactive visualization system in accordance with some configurations. As illustrated in FIGS. 8A-8B, the skill gap user interface 800 may include a directional dumbbell chart 805. The directional dumbbell chart 805 may be configured to visualize a skill gap (or difference) between a current job role (represented by reference numeral 810) and a target job role (represented by reference numeral 815). As illustrated in FIGS. 8A-8B, for each skill, an arrowed line between two bar ticks (representing the current and target jobs) highlights the skill gap. The skills are sorted by proficiency gap, with background dots marking the proficiency level of each skill. This allows users to check the details of the skill proficiency descriptions at a particular level. For example, when a user interacts with (by selecting or hovering over) the Leadership skill, the electronic processor 300 may generate and provide a pop-up window 850. As illustrated in FIGS. 8A-8B, the pop-up window 850 may provide one or more skill proficiency descriptions for the Leadership skill at the Proficient level. Alternatively, or in addition, the skill gap may be represented using, e.g., a diverging bar chart, a heatmap, an area chart, etc.

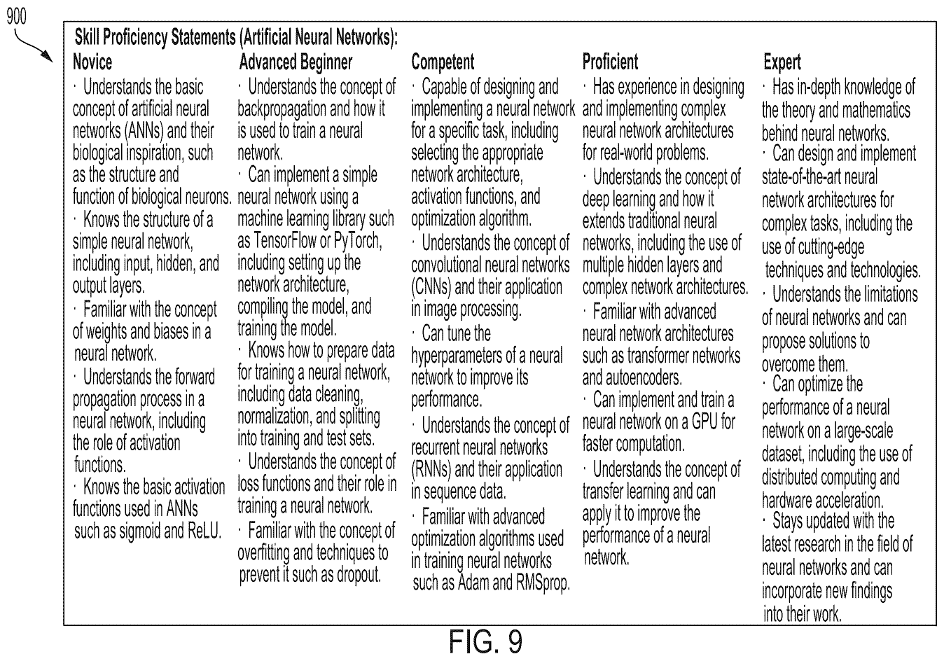

FIG. 9 illustrates an example skill proficiency user interface 900 that represents the skill proficiency view of the interactive visualization system in accordance with some configurations. As illustrated in FIG. 9, the skill proficiency user interface 900 includes an table that displays the skill proficiency statements for a selected skill. In the illustrated example, the skill proficiency descriptions are each level are presented in a list format rather than in, e.g., a table row. Such an arrangement prevents the deceptive effect of table rows, where users might incorrectly assume that the skill proficiency description on the same row are related to each other. As also illustrated in FIG. 9, the skill gaps may be visually distinguished within the table (e.g., highlighted in a color).

As noted herein, in some instances, a user may interact with various components or elements displayed by the interactive visualization system (e.g., in the career pathways user interface 700, the skill gap user interface 800, the skill proficiency user interface 900, or a combination thereof). In some configurations, the following interactions may be coordinated across the three views: hovering over a node or edge to show the details of a job or a transition; clicking on a node to select a target job title and explore the skill gaps; double-clicking on a node to further explore its relevant career pathway; or clicking on a skill or hovering over a skill at a particular level to explore the skill proficiency statements.

The technology disclosed herein, including, e.g., the skill proficiency by occupation model, may be implemented in various applications, including, e.g., individuals and career advisors, recruiters and hiring managers, employers and HR professionals, or educators and training providers.

### Individuals and Career Advisors Application.

As a first example application or use case, the technology disclosed herein may be implemented with respect to individuals and career advisors. The skill proficiency framework serves as a powerful tool for both individuals seeking career advancement and career advisors guiding those individuals. The skill proficiency framework provides valuable insights into career pathways, highlighting the progression and transitions between different roles. Furthermore, The skill proficiency framework can shed light on skill development, identifying the key requisite skills for each role and the requisite proficiency level. Such information can help individuals plan their career trajectory more effectively and enable career advisors to provide more tailored, informed advice.

An example fictional scenario may include the following: Emma, a data scientist with three years' working experience, would like to explore her career pathway and understand the skill proficiency requirements for different roles.

In a first scenario, Emma starts by searching for her current job title, Data Scientist, in the career pathway view (e.g., the career pathways user interface 700 of FIG. 7) (represented in FIG. 7 by reference numeral 730). She then explores potential career paths by hovering over the nodes and edges. She sees that she can progress to a Senior Data Scientist role, and further to a Lead Data Scientist role (represented in FIG. 7 by reference numeral 735). Alternatively, she could transition from an individual contributor (IC) to the management path as a Data Science Manager (represented in FIG. 7 by reference numeral 740). She also discovers that she can switch career to a Machine Learning Engineer/Researcher or an AI Research Scientist (represented in FIG. 7 by reference numeral 745), both of which could offer a higher salary. Emma is particularly interested in the AI Research Scientist role, so she hovers over on the node to see the details (e.g., the pop-up window 710 of FIG. 7) and then double-clicks it to further explore the relevant career pathways.

A second scenario relates to a skill gap analysis. After reviewing the career pathway, Emma decides she aspires to transition to the AI Research Scientist role. She clicks on the Lead AI Research Scientist node (represented in FIG. 7 by reference numeral 750) as her target role (represented FIGS. 8A-8B by reference numeral 855). The system displays the skill gap between her current position and the target role, highlighting skills she may need to acquire or improve. She learns that she might need to gain skills such as Deep Learning, Research, PyTorch, Computer Vision, and Leadership (represented in FIGS. 8A-8B by reference numeral 855). Additionally, she may need to further develop her knowledge and skills of Artificial Neural Networks, Time Series, Statistics, and Cloud Computing (represented in FIGS. 8A-8B by reference numeral 860). The skill gap, which highlights both the estimated current proficiency level and the required proficiency level for the target role, helps Emma to understand the areas she needs to focus on to reach her career goal. She can hover over on a dot or the bar tick to check the detailed proficiency requirements of that level in a tooltip (e.g., the pop-up window 850 of FIGS. 8A-8B).

A third scenario relates to skill proficiency prerequisites. The system estimates Emma's proficiency in Artificial Neural Networks as Advanced Beginner, based on her current role as a Data Scientist. However, a Lead AI Research Scientist position requires a Proficient level in this skill. Emma clicks on Artificial Neural Networks to explore the requisites for reaching the proficient level (e.g., via the skill proficiencies user interface 900 of FIG. 9). She discovers that to be proficient, she needs to: “be capable of designing and implementing a neural network for a specific task, including selecting the appropriate network architecture, activation functions, and optimization algorithm,” “understand the concept of convolutional neural networks (CNNs) and their application in image processing,” and “[have] experience in designing and implementing complex neural network architectures for real-world problems, etc.”

### Recruiters and Hiring Managers Application.

The skill proficiency framework is a valuable resource for recruiters and hiring managers. It can help them identify the skill requisites for different roles, assess the proficiency levels of job candidates, and make more informed hiring decisions. By understanding the skill proficiency requisites for various roles, recruiters and hiring managers can create job descriptions/postings more efficiently, better match candidates to job requisites and ensure that new hires have the requisite skills to succeed in their roles.

A first example scenario relates to creating job postings. A hiring manager at a biotechnology company is looking to fill a Medical and Clinical Laboratory Technologists position. The hiring manager may use the skill proficiency by occupation model to identify the key requisite skills for the role and create a job posting that accurately reflects the skill requisites. The hiring manager specifies that candidates should have skills such as Laboratory Testing, Quality Control (QC), Hematology and Verbal Communication Skills at the Competent level. The hiring manager may also include additional skills such as Equipment Maintenance and Patient Records as desirable but not required as these Advanced Beginner skills can be taught as part of on-boarding training. By using the skill proficiency by occupation model to define the skill requisites for the role, the hiring manager can attract candidates with the right skills and experience.

A second example scenario relates to internal mobility. A hiring manager is reviewing their current employees to fill a position for an upcoming project: Medical Research Assistants. The hiring manager may utilize the skill proficiency by occupation model to identify and assess the proficiency levels of relevant employees and match them to the skill requisites for the role. The hiring manager compares the proficiency levels of the candidates in key skills such as Project Management, Clinical Research, Clinical Trials, and Communication Skills against the proficiency requisites for the position. Through this process, the hiring manager may identify candidates who not only meet the skill requisites but also have the potential to excel in the role. By employing the skill proficiency by occupation model to align candidates with job requisites, the hiring manager makes more informed decisions, ensuring the selection of the best-fit candidates for the position. Additionally, the hiring manager can integrate their organization's job architecture with the interactive visualization system described herein to identify the top internal candidates for the role, and provide them the necessary training to bridge any skill gaps.

A third example scenario relates to candidate assessment. A hiring manager is interviewing a candidate for a Registered Nurse position. The hiring manager may use the skill proficiency by occupation model to assess the candidate's proficiency levels in key skills such as Patient Monitoring, Patient Records, Discharge Planning, and Communication Skills. The hiring manager asks the candidate to describe their experience and expertise in each skill and evaluates their proficiency level based on their responses. By using the skill proficiency by occupation model to assess the candidate's skills, the hiring manager can gain a better understanding of the candidate's qualifications and make an informed decision about whether to hire them for the role.

### Employers and HR Professionals Application.

The skill proficiency framework can also be beneficial for employers and HR professionals. The skill proficiency framework can help employers and HR professionals identify the skill requisites for different roles, assess the proficiency levels of their employees, and develop training programs to bridge skill gaps. By understanding the skill proficiency requisites for various roles, employers can make more informed decisions when recruiting, promoting, or training employees.

A first example scenario relates to workforce planning. An HR manager at a large corporation is planning to expand their marketing team. The HR manager may use the skill proficiency by occupation model to identify the key requisite skills for different roles and assess the proficiency levels of their current employees. The HR manager compares the skill requisites for roles such as Brand Designers, Digital Content Specialists, and Social Media Marketing Managers to the proficiency levels of their employees and identifies skill gaps to be addressed. By using the skill proficiency by occupation model for workforce planning, the HR manager can ensure that they have the right skills and expertise within their team to meet the company's needs.

A second example scenario relates to talent development. A manager is looking to develop the skills of their team members to help them advance in their careers. The manager may use the skill proficiency by occupation model to assess the proficiency levels of their employees and identify areas to improve. The manager creates a personalized training plan for each team member based on each team member's skill gaps and career goals. By using the skill proficiency by occupation model for talent development, the manager can help their team members develop the skills to succeed in their current roles and advance in their careers.

A third example scenario relates to performance evaluation. A manager is evaluating the performance of their team members and looking to identify areas where they can improve. The manager may use the skill proficiency by occupation model to assess the proficiency levels of their employees and compare them to the skill requisites for their roles. The manager identifies skill gaps that may be impacting their team members' performance and creates a development plan to help them address these gaps. By using the skill proficiency by occupation model for performance evaluation, the manager can provide targeted feedback and support to help their team members improve their skills and succeed in their roles.

### Educators and Training Providers Application.

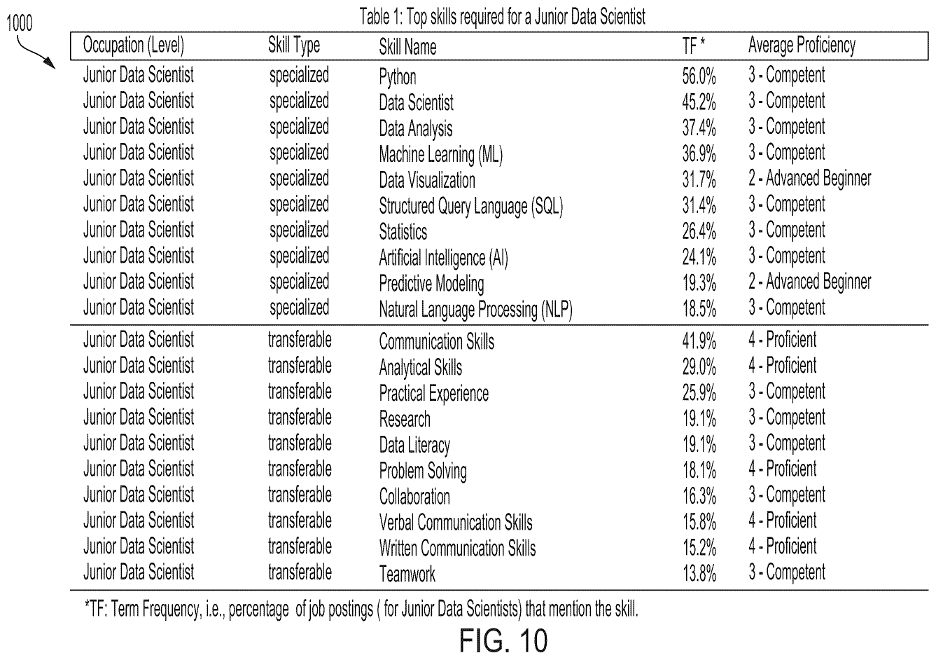

The skill proficiency framework may serve as a tool for educators and training providers. The skill proficiency framework may assist in pinpointing requisite skills for various roles, evaluating students' proficiency levels, and creating training programs to address skill gaps. By comprehending the proficiency requisites for different positions, educators and trainers can develop more effective programs that better prepare students for success in their careers. For example, FIG. 10 illustrates a table 1000 of top skills associated with a junior data scientist.

A first example scenario relates to curriculum and program design. A university is designing an online Master of Data Science program and wants to ensure that the curriculum covers the key requisite skills for the field. The university may use the skill proficiency by occupation model to identify the requisite skills for graduate/junior data scientists (as illustrated in the table 1000 of FIG. 10) and create a curriculum that aligns with these requisites. The university includes courses such as Introduction to Data Science and Introduction to Python Programming to ensure that students develop Python, Data Science, and Data Analysis skills to at least the Competent level, as demanded by the job market. Additional courses such as Practical Data Science with Python, Data Visualization and Analysis, Applied Analytics (Statistics), and Machine Learning are also included to ensure that students acquire the skills to excel in the field. The objectives of each course will be set to ensure that assignments, projects, and assessments are designed not only to develop technical skills but also to enhance relevant transferable skills such as communication, teamwork, and problem-solving. This holistic approach aims to prepare students for success in their data science careers.

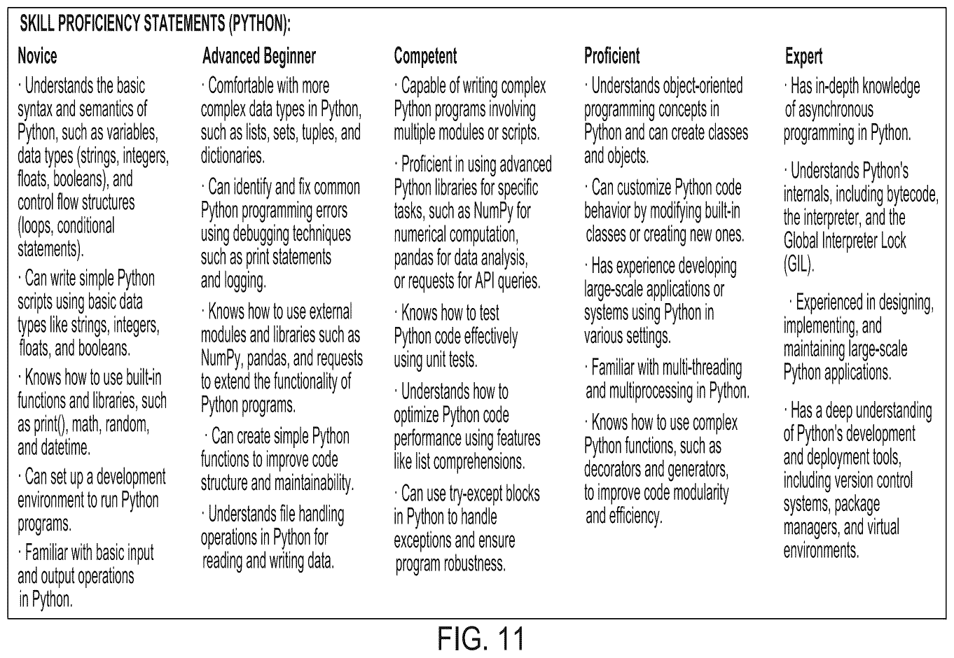

A second example scenario relates to course design. The skill proficiency descriptions can also assist professors in designing individual courses within a curriculum. For example, in the Introduction to Python Programming course, the university can ensure that course covers the key concepts and applications of Python for data science. After reviewing the skill proficiency requisites for Python (e.g., as illustrated in FIG. 11), the professors might decide to cover proficiency levels from Beginner to Competent as part of a 6-week course that covers concepts and applications of Python for data science. They can design assignments, projects, and assessments that help students develop the skills to reach these proficiency levels. For instance, in the first two weeks, the course introduces Python and helps students to: “set up a development environment to run Python programs” (Novice level); “understand the basic syntax and semantics of Python, such as variables, data types (strings, integers, floats, booleans), and control flow structures (loops, conditional statements)” (Novice level); and “use built-in functions and libraries, such as print( ) math, random, and datetime” (Novice level). By the third week, students become “comfortable with more complex data types in Python, such as lists, sets, tuples, and dictionaries”, and learn how to “identify and fix common Python programming errors using debugging techniques such as print statements and logging” (Advanced Beginner level).

A third example scenario relates to student assessment. An instructor is teaching a Risk Analysis course and wants to assess the proficiency levels of their students. The instructor may use the skill proficiency by occupation model to evaluate the students' skills in areas such as Risk Analytics, Risk Management Plans, and Opportunity Analysis. The instructor creates assignments and assessments that test the students' proficiency in these skills and provides feedback to help them improve. By using the skill proficiency by occupation model for student assessment, the instructor can gain a better understanding of the students' skills and provide targeted support to help them succeed in the course.

Accordingly, as described herein, the skill proficiency framework provides a structured method to help describe, assess, and develop proficiency in key skills, facilitating individuals' career pathways and aiding organizations in talent management and adaptability. By establishing a standardized proficiency language across occupations and integrating insights from the skill proficiency by occupation model, the skill proficiency framework described herein enables comparison of skill requisites across various job roles, and, as such, is effective in enhancing workforce planning, education, or training efforts. Compared to existing frameworks, the skill proficiency framework described herein allows for rapid updates of the skills ontology and the generation of new skill proficiency descriptions in response to emerging job market demands. By leveraging job posting data, the skill proficiency framework described herein also provides up-to-date insights into market demand for specific proficiencies and occupations, significantly enhancing the utility of the skill proficiency framework described herein in workforce and career planning, educational program design, etc.

In some examples, aspects of the technology, including computerized implementations of methods according to the technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, examples of the technology can be implemented as a set of instructions, tangibly embodied on a non-transitory computer-readable media, such that a processor device can implement the instructions based upon reading the instructions from the computer-readable media. Some examples of the technology can include (or utilize) a control device such as an automation device, a special purpose or general-purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

Certain operations of methods according to the technology, or of systems executing those methods, can be represented schematically in the FIGS. or otherwise discussed herein. Unless otherwise specified or limited, representation in the FIGS. of particular operations in particular spatial order can not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular examples of the technology. Further, in some examples, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component can be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) can reside within a process or thread of execution, can be localized on one computer, can be distributed between two or more computers or other processor devices, or can be included within another component (or system, module, and so on).

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as “either,” “one of,” “only one of,” or “exactly one of.”

Although the present technology has been described by referring to preferred examples, those skilled in the art will recognize that changes can be made in form and detail without departing from the scope of the discussion.

What is claimed is:

1. A system, the system comprising:
a processing system including one or more electronic processors configured to:
access a skills ontology that indicates a plurality of skills;
generate a plurality of skill proficiency descriptions for the plurality of skills, wherein each skill proficiency description of the plurality of skill proficiency descriptions:
(a) is specific to a respective skill of the plurality of skills and a corresponding proficiency level of the respective skill of the plurality of skills; and
(b) indicates a corresponding requisite associated with performance of the respective skill at the corresponding proficiency level;
extract, from occupation data stored in an external database, a set of skills of the plurality of skills, the set of skills indicated by the occupation data;
determine, from the occupation data, a set of proficiency levels, wherein each skill of the set of skills is associated with a respective proficiency level of the set of proficiency levels;
determine, from the occupation data, an occupation having a corresponding designation; and
generate a model that correlates the occupation having the corresponding designation to a first skill proficiency description of the plurality of skill proficiency descriptions, wherein the first skill proficiency description indicates a first requisite associated with performing a first skill of the set of skills at a first respective proficiency level of the set of proficiency levels.

2. The system of claim 1, wherein the processing system is further configured to:
determine a plurality of skill types for the plurality of skills, wherein each skill of the plurality of skills is associated with a respective skill type of the plurality of skill types; and
wherein the first skill proficiency description is generated based on a skill type of the first skill of the set of skills.

3. The system of claim 2, wherein the plurality of skill types includes at least one of a knowledge-based skill type, a personal attribute skill type, or a physical attribute skill type.

4. The system of claim 1, wherein the processing system is further configured to:
determine whether the plurality of skill proficiency descriptions satisfy a language diversity condition, wherein the language diversity condition verifies vocabulary diversification between the plurality of skill proficiency descriptions.

5. The system of claim 1, wherein the processing system is further configured to:
determine whether the first skill proficiency description satisfies a bias condition; and
when the first skill proficiency description fails to satisfy the bias condition, modify the first skill proficiency description to remove the bias condition.

6. The system of claim 1, wherein the processing system is further configured to:
validate the first skill proficiency description based on at least one of: an alignment of the first skill proficiency description to a course description related to the first skill; a comparison of the first skill proficiency description to another framework; or domain expert review feedback.

7. The system of claim 1, wherein the processing system is configured to generate the plurality of skill proficiency descriptions using a large language model (LLM).

8. The system of claim 1, wherein the processing system is configured to:
generate, based on the model, a graphical representation of the model, wherein the graphical representation provides a visual representation of a correlation between the occupation and an additional occupation; and
transmit the graphical representation for display via a display device of a user device.

9. The system of claim 8, wherein the graphical representation is a directional node-link diagram, wherein the occupation is represented by a first node and the additional occupation is represented by a second node, wherein the first node and the second node are connected by a first edge, wherein the first edge represents a transition between the occupation and the additional occupation.

10. The system of claim 9, wherein the processing system is configured to:
detect an user interaction with the first node; and
responsive to detecting the user interaction with the first node, display additional information related to the occupation.

11. The system of claim 1, wherein the processing system is configured to:
determine, for a user, a difference between the set of skills associated with the occupation and an additional set of skills, of the plurality of skills, associated an additional occupation;
generate a graphical representation of the difference, wherein the graphical representation provides a visual comparison of the set of skills associated with the occupation and the additional set of skills associated with the additional occupation; and
transmit the graphical representation for display via a display device of a user device.

12. The system of claim 11, wherein the processing system is configured to:
detect a user interaction with an additional skill included in the additional set of skills; and
responsive to detecting the user interaction, display additional information related to the additional skill, wherein the additional information includes a respective proficiency level of the additional skill and an additional skill proficiency description that indicates an additional requisite associated with performing a additional skill of the additional set of skills at the respective proficiency level.

13. A method, the method comprising:
accessing, with a processing system including one or more electronic processors, a skills ontology that indicates a plurality of skills;
generating, with the processing system, using a large language model (LLM), a first skill proficiency description for a first skill of the plurality of skills, wherein the first skill proficiency description is specific to the first skill and a first corresponding proficiency level of the first skill, wherein the first skill proficiency description indicates a first requisite associated with performance of the first skill at the first corresponding proficiency level;
accessing, with the processing system, external occupation data related to a plurality of occupations;
determining, with the processing system, based on the external occupation data, a mapping that correlates each occupation of the plurality of occupations to a respective set of skills of the plurality of skills, wherein each skill of the respective set of skills is associated with a respective proficiency level;
generating, with the processing system, based on the mapping, a model that correlates a first occupation of the plurality of occupations to the first skill proficiency description;
generating, with the processing system, a user interface including an interactive graphical representation of the model; and
transmitting, with the processing system, the user interface including the interactive graphical representation of the model to a user device for display by a display device of the user device.

14. The method of claim 13, further comprising:
generating, with the processing system, using the LLM, a second skill proficiency description for a second skill of the plurality of skills, wherein the second skill proficiency description is specific to the second skill and a second corresponding proficiency level of the second skill, wherein the second skill proficiency description indicates a second requisite associated with performance of the second skill at the second corresponding proficiency level; and
wherein generating, with the processing system, the model includes generating the model to correlate a second occupation of the plurality of occupations to the second skill proficiency description.

15. The method of claim 13, further comprising:
determining, with the processing system, that the first skill proficiency description satisfies a language diversity condition, wherein the language diversity condition verifies vocabulary diversification between a plurality of skill proficiency descriptions, the plurality of skill proficiency descriptions including the first skill proficiency description; and
subsequent to determining that the first skill proficiency description satisfies the language diversity condition, determining, with the processing system, that the first skill proficiency description satisfies a bias condition.

16. The method of claim 13, further comprising:
detecting, with the processing system, a user interaction with the user interface, the user interaction including a first selection of the first occupation and a second selection of a second occupation of the plurality of occupations; and
responsive to the user interaction,
performing, with the processing system, a skills comparison of a first set of skills associated with the first occupation and a second set of skills associated with the second occupation, wherein the first skill is included in the first set of skills associated with the first occupation;
determining, with the processing system, based on the skills comparison, a skills gap between the first set of skills associated with the first occupation and the second set of skills associated with the second occupation;
generating, with the processing system, a graphical representation of the skills gap; and
transmitting, with the processing system, the graphical representation of the skills gap to the user device for display by the display device of the user device.

17. A non-transitory, computer-readable medium storing instructions that, when executed by an electronic processor, perform a set of functions, the set of functions comprising:
accessing a skills ontology that indicates a plurality of skills;
developing a plurality of LLM prompts to generate a plurality of skill proficiency descriptions for the plurality of skills, wherein each LLM prompt of the plurality of LLM prompts is specific to a corresponding skill of the plurality of skills and is based on a skill type of the corresponding skill of the plurality of skills;
executing a plurality of LLM queries using the plurality of LLM prompts to generate the plurality of skill proficiency descriptions for the plurality of skills, wherein each skill proficiency description of the plurality of skill proficiency descriptions:
(a) is specific to a respective skill of the plurality of skills and a corresponding proficiency level of the respective skill of the plurality of skills; and
(b) indicates a corresponding requisite associated with performance of the respective skill at the corresponding proficiency level;
extracting, from occupation data stored in an external database, a set of skills of the plurality of skills, the set of skills indicated by the occupation data;
determining, from the occupation data, a set of proficiency levels, wherein each skill of the set of skills is associated with a respective proficiency level of the set of proficiency levels;
determining, from the occupation data, an occupation having a corresponding designation;
generating a mapping the occupation having the corresponding designation to the set of skills and the set of proficiency levels; and
generating, based on the mapping, a model that correlates the occupation having the corresponding designation to a first skill proficiency description of the plurality of skill proficiency descriptions, wherein the first skill proficiency description indicates a first requisite associated with performing a first skill of the set of skills at a first respective proficiency level of the set of proficiency levels.

18. The computer-readable medium of claim 17, wherein the set of functions further comprises:
executing, using at least one of a language diversity condition or a bias condition, a verification process with respect to each of the plurality of skill proficiency descriptions; and
updating the first skill proficiency description based on an outcome of the verification process.

19. The computer-readable medium of claim 17, wherein the set of functions further comprises:
generating a user interface including an interactive graphical representation of the model; and
transmitting the user interface including the interactive graphical representation of the model to a user device for display by a display device of the user device.

20. The computer-readable medium of claim 17, wherein the set of functions further comprises:
receiving domain expert feedback for the first skill proficiency description; and
validating the first skill proficiency description based on the domain expert feedback.
